(19) United States
(12) Patent Application Publication
(10) Pub. No.: US 2008/0264404 A1
(43) Pub. Date: Oct. 30, 2008

(54) BARBECUE GRILL

(75) Inventors: Victor Hoyles, Kitchener (CA); Kristoffer Hess, Cambridge (CA); Kelly Stinson, Kitchener (CA); David L. Hobb, Waterloo (CA)

Correspondence Address: VALENTINE A COTTRILL;SUSAN TANDAN, 50 QUEEN STREET NORTH, STE. 1020, P.O. BOX 2248, KITCHENER, ON, N2H6M2, CA

(73) Assignee: DIMPLEX NORTH AMERICA LIMITED, Cambridge (CA)

(21) Appl. No.: 12/170,049

(22) Filed: Jul. 9, 2008

Related U.S. Application Data
(63) Continuation-in-part of application No. 11/967,551, filed on Dec. 31, 2007.
Application No. 11/967,551 is a continuation-in-part of application No. 11/855,748, filed on Sep. 14, 2007.
Application No. 11/855,748 is a continuation-in-part of application No. 11/620,906, filed on Jan. 8, 2007.

(51) Int. Cl. A47J 37/00

(52) U.S. Cl. 126/25 R

(57) ABSTRACT

A barbecue grill for cooking an object. The barbecue grill includes a number of ribs for supporting the object. Each rib has one or more resistive elements and one or more body portions substantially electrically insulated by an insulator relative to the resistive element. The body portion includes a top surface adapted for engaging the object. Each rib is spaced apart from at least one of the ribs proximal thereto by a predetermined distance to allow liquid escaping from the object to flow between the ribs under the influence of gravity.

This application is a continuation-in-part of application Ser. No. 11/967,551, filed Dec. 31, 2007, which is a continuation-in-part of application Ser. No. 11/855,748, filed Sep. 14, 2007, which is a continuation-in-part of application Ser. No. 11/620,906, filed Jan. 8, 2007.

### FIELD OF THE INVENTION

The present invention relates to a barbecue grill and a barbecue assembly including same.

### BACKGROUND OF THE INVENTION

Electric barbecue grills are known. In general, it is difficult to provide sufficient radiated heat to cook the barbecued meat (or any other object to be cooked) to the extent required using known electric barbecue grills. Also, it is difficult to provide sufficient conducted heat through grill elements to create dark barbecue grill markings on the meat in known electrical barbecue grills. In particular, in known electric barbecue grills, providing the required amounts of such heat (i.e., radiated heat and conducted heat) in the appropriate proportions relative to each other has proven to be extremely difficult to achieve.

In known electric barbecues, the manner in which grease and other liquids released from the barbecued object during barbecuing are dealt with also appears to have been problematic. For instance, U.S. Pat. No. 5,488,897 (Snyder) discloses a structure in which an electric heating element is mounted onto an aluminium heater plate, which is attached to the bottom of an extruded or cast aluminium cooking grid with a number of grill elements. A food product to be barbecued is positioned on the grill elements, and heated. In Snyder, however, grease and other liquids from the barbecued product are not allowed to fall between the grill elements. Instead, in the Snyder invention, grease and other liquids are collected off the top surfaces of the grid and then directed away from the grid (and the electric heating element), instead of falling through the grid.

Another prior art barbecue grill is disclosed in U.S. Pat. No. 5,105,725 (Haglund). Unlike the grid disclosed in Snyder, the grid element (68) in Haglund includes “vent holes” (10) which are described as permitting hot gases generated by a heat source beneath the grid to pass upwardly, permitting “a certain amount” of liquid from the food product to pass therethrough, and also permitting thermal expansion and contraction of the grid (col. 5, lines 66-68 and col. 6, line 1-8). The grid element is intended for use in a variety of barbecues, including barbecues with “electrical heating elements” (col. 1, lines 13-16).

The vent holes in the Haglund grid are arranged in a “staggered” pattern (col. 6, lines 33-39). The shapes of the openings may be as desired (col. 6, lines 47-56). However, the Haglund patent teaches that the overall area of the vent holes should be limited to between about 10 percent and about 25 percent of the total area of the “planar base” of the grid (col. 6, lines 57-66). This range is said “to provide a good balance”, for the following reasons (col. 6, lines 66-68 and col. 7, lines 1-11):
If the base 4 collects too much fat, then the fat can ignite which chars the meat resting on the grill rails 8. Also, if an excessive area is provided by the vent holes 10, then it is possible for flames originating from below the base 4 to pass upwardly through the vent holes 10 and char the meat being cooked on the grill rails 8. A minimum area of solid base is also desirable in order to collect fat and other juices dripping from the meat and other food products being cooked on the grid element 2. The hot base 4 cooks the dripping fat and juices, and generates a certain amount of smoke and flavored gases which provide a “barbecue-type” flavor to the meat and other food products.

It appears that, in each of the grids disclosed in the Snyder and Haglund patents, a significant amount of grease and other liquids from a barbecued article would tend to remain on the prior art grid. However, as is known in the art, where grease and other liquids (and pieces of the barbecued food article) remain on the grid, they tend to become baked on the grid, ultimately adversely affecting the efficiency of the grid. Also, the accumulated materials may result in excessive smoke and other undesirable effects.

There is therefore a need for an improved barbecue grill which overcomes or mitigates one or more of the disadvantages of the prior art.

### SUMMARY OF THE INVENTION

In its broad aspect, the invention provides a barbecue grill for cooking an object. The barbecue grill includes a number of ribs for supporting the object. Each rib has one or more resistive elements and one or more body portions which are substantially electrically insulated by an insulator relative to the resistive element. The resistive element is energizable for generating heat to at least partially cook the object, and the insulator is engaged with the body portion for heat transfer by conduction to the body portion. The body portion includes a top surface adapted for engaging the object. The ribs are positioned to locate the top surface of each rib substantially in a plane, each rib being spaced apart from at least one of the ribs proximal thereto by a predetermined distance to allow liquid escaping from the object to flow between the ribs under the influence of gravity.

In another aspect, the ribs are movable between at least one grill position, in which the ribs are positioned for grilling the object, and at least one broil position, in which the ribs are positioned for broiling the object. The resistive element is energizable in each of the barbecue grill position and the broil position for generating heat to at least partially cook the object.

In yet another aspect, the invention provides an upper resistive element subassembly energizable for generating heat to cook the object and positionable a preselected distance apart from the ribs, for heat transfer to the object by radiation.

In another aspect, the invention provides an upper resistive element subassembly energizable for generating heat to at least partially cook the object located a preselected distance above the ribs, for heat transfer by radiation when the ribs are in the grill position.

In another aspect, the upper resistive element subassembly comprises one or more resistive elements and one or more body portions substantially electrically insulated relative to the resistive element.

In another of its aspects, the invention provides a barbecue assembly for cooking an object. The barbecue assembly includes the barbecue grill and a tub for supporting the barbecue grill.

In yet another aspect, the tub includes a bottom portion for supporting the barbecue grill, and a top portion movable relative to the bottom portion between a closed position, in which the upper resistive element subassembly is positioned above the barbecue grill, and an open position, in which the barbecue grill is accessible. The upper resistive element subassembly is mounted in the top portion.

In yet another of its aspects, the invention provides a method of forming a rib in a barbecue grill for cooking an object. The method includes, first, providing a body portion comprising one or more contact surfaces. Next, one or more resistive element subassemblies at least partially adapted for engagement with the contact surface for transferring heat to the body portion by conduction is provided. The resistive element subassembly comprises a sheath, an insulator, and one or more electrically resistive elements substantially electrically insulated from the sheath by the insulator. The body portion includes a central part and a ridge part extending therefrom, the ridge part comprising one or more body segments. In the next step, the sheath of the resistive element subassembly is engaged with the contact surface. Finally, the body segment is engaged with the resistive element subassembly, to urge the sheath against the contact surface.

In yet another aspect, the invention provides a method of forming a rib in a barbecue grill including, first, providing a first body portion with a top surface adapted for engaging the object to be cooked and one or more contact surfaces, and second, positioning a first insulator layer on the contact surface. Next, one or more resistive elements is engaged with the first insulator layer. A second insulator layer is then engaged with the resistive element so that the resistive element is positioned between the first and second insulator layers. The first and second insulator layers and the resistive element comprise an insulated heat-generating subassembly. Next, the insulated heat-generating subassembly is engaged with a second body portion to urge the insulated heat-generating subassembly against the contact surface of the first body portion for heat transfer by conduction from the insulated heat-generating subassembly to the first body portion. The insulator layers substantially electrically insulate the resistive element relative to the first and second body portions respectively.

In another of its aspects, the invention provides a method of forming a rib in a barbecue grill including, first, providing a first body portion with a top surface adapted for engaging the object and one or more contact surfaces, and second, positioning a resistive element in a preselected position relative to the contact surface. Next, an insulator is positioned around the resistive element, the insulator substantially electrically insulating the resistive element relative to the first body portion. The insulator is adapted for bonding with the contact surface. The resistive element and the insulator comprise an insulated heat-generating subassembly. Finally, a second body portion with the insulated heat-generating subassembly to hold the insulated heat-generating subassembly against the contact surface for heat transfer by conduction from the insulated heat-generating subassembly to the first body portion.

In yet another of its aspects, the invention provides a method of forming a rib in a barbecue grill including, first, forming a sheath portion into a predetermined shape in which the sheath portion includes a top surface adapted for engaging the object, and second, positioning one or more resistive elements in the sheath portion. Finally, an insulator is positioned inside the sheath portion for substantially electrically insulating the resistive element relative to the sheath portion, the insulator engaging the sheath portion for heat transfer by conduction for said at least one resistive element to the sheath portion via the insulator.

In another aspect, the invention provides a method of forming a rib in a barbecue grill including, first, providing a body portion with at least one or more contact surfaces inside the body portion, and second, positioning a sheathed element in the body portion. A top surface is formed on the body portion which is adapted to engage the object. Finally, the body portion is formed to urge the contact surface against the sheathed element, for heat transfer by conduction from the sheathed element to the body portion.

In yet another of its aspects, the invention provides a barbecue grill including a plurality of elongate ribs having central portions respectively for supporting the object, the ribs being spaced apart from each other by at least a first preselected distance respectively to permit liquid from the object to pass between the ribs under the influence of gravity. The barbecue grill also includes one or more sheathed elements having a sheath, a resistive element at least partially positioned therein, and an insulator substantially electrically insulating the resistive element relative to the sheath portion. The sheathed element is positioned a second preselected distance below the object. Also, each sheathed element is connected to a rib for transferring heat by conduction to the rib.

### BRIEF DESCRIPTION OF THE DRAWINGS

The invention will be better understood with reference to the attached drawings, in which:

FIG. 1 is an isometric view of an upper side of an embodiment of a barbecue grill of the invention;

FIG. 2A is a cross-section of a portion of the barbecue grill of FIG. 1, drawn at a larger scale;

FIG. 2B is a cross-section of an embodiment of a barbecue assembly of the invention including the barbecue grill of FIG. 1, drawn at a smaller scale;

FIG. 3A is an isometric view of a lower side of an alternative embodiment of a barbecue grill of the invention, drawn at a smaller scale;

FIG. 3B is an isometric view of an upper side of the barbecue grill of FIG. 3A;

FIG. 4A is a cross-section of a portion of the barbecue grill of FIG. 3A, drawn at a larger scale;

FIG. 4B is a cross-section of another embodiment of a barbecue assembly of the invention including the barbecue grill of FIG. 4A, drawn at a smaller scale;

FIG. 5 is an isometric view of an upper side of an alternative embodiment of a barbecue grill of the invention, drawn at a smaller scale;

FIG. 6 is a top view of the barbecue grill of FIG. 5, drawn at a larger scale;

FIG. 7 is a cross-section of a portion of the grill of FIG. 6, drawn at a larger scale;

FIG. 8 is an isometric view (partially cut away) of a rib in the barbecue grill of FIG. 6, drawn at a larger scale;

FIG. 9 is an isometric view of a lower side of the barbecue grill of FIG. 6, drawn at a smaller scale;

FIG. 10 is a cross-section of a portion of an alternative embodiment of the barbecue grill of the invention, drawn at a larger scale;

FIG. 11 is an isometric view of an alternative embodiment of the barbecue grill of the invention, drawn at a smaller scale;

FIG. 12 is a top view of the barbecue grill of FIG. 11, drawn at a larger scale;

FIG. 13 is an isometric view (partially cut away) of an embodiment of a barbecue assembly of the invention;

FIG. 14 is a cross-section of the barbecue grill assembly of FIG. 13;

FIG. 15 is an isometric view of another alternative embodiment of the barbecue assembly of the invention in which an alternative embodiment of the barbecue grill of the invention is mounted in the grill position, drawn at a smaller scale;

FIG. 16 is an isometric view of the barbecue assembly of FIG. 15 in which the barbecue grill is mounted in the broil position;

FIG. 17A is an isometric view (in partial cross-section) of the barbecue grill of FIG. 16;

FIG. 17B is a cross-section of portions of the first and second resistive subassemblies, drawn at a larger scale;

FIG. 18A is a top view of the barbecue grill of FIG. 17, drawn at a smaller scale;

FIG. 18B is a circuit diagram schematically illustrating certain elements of the barbecue grill of FIG. 18A;

FIG. 19 is a partial cross-section of the barbecue assembly of FIG. 16, drawn at a larger scale;

FIG. 20 is an isometric view (partially cut away) of the barbecue assembly of FIG. 16 showing the barbecue grill in the broil position, drawn at a smaller scale;

FIG. 21 is another isometric view (partially cut away) of the barbecue assembly of FIG. 15 showing the barbecue grill in the grill position, drawn at a smaller scale;

FIG. 22 is a cross-section of the barbecue assembly of FIG. 21;

FIG. 23 is an isometric view of a portion of the barbecue assembly of FIG. 16 showing the barbecue grill in the broil position, drawn at a larger scale;

FIG. 24 is a cross-section of an embodiment of a connector assembly of the invention;

FIG. 25 is an isometric view of another alternative embodiment of the barbecue assembly of the invention showing the grill in the grill position, drawn at a smaller scale;

FIG. 26 is an isometric view of the barbecue assembly of FIG. 25 showing the grill in a raised position;

FIG. 27 is an isometric view (in partial cross-section) of another embodiment of a barbecue grill of the invention, drawn at a larger scale;

FIG. 28 is a cross-section of a portion of the barbecue grill of FIG. 27, drawn at a larger scale;

FIG. 29 is a top view of the barbecue grill of FIG. 27, drawn at a smaller scale;

FIG. 30A is a side view (in partial cross-section) of another embodiment of a barbecue assembly of the invention, drawn at a smaller scale;

FIG. 30B is a side view (in partial cross-section) of another embodiment of a barbecue assembly of the invention, showing a top portion of a tub thereof in an open position, drawn at a smaller scale;

FIG. 30C is a side view (in partial cross-section) of the barbecue assembly of FIG. 30B with the top portion in a closed position;

FIG. 31 is an isometric view (partially cut away) of the barbecue assembly of FIG. 30 showing the barbecue grill in the broil position, drawn at a smaller scale;

FIG. 32 is a cross-section of the barbecue assembly of FIG. 31 with the barbecue grill in the grill position;

FIG. 33A is a cross-section of another embodiment of a rib of the invention showing an early step in the assembly thereof, drawn at a larger scale;

FIG. 33B is a cross-section of the rib of FIG. 33A showing an intermediate step in the assembly thereof;

FIG. 33C is a cross-section of the rib of FIG. 33B in which the rib is assembled;

FIG. 34A is a cross-section of another embodiment of a rib of the invention showing an early step in the assembly thereof, drawn at a smaller scale;

FIG. 34B is a cross-section of the rib of FIG. 34A showing an intermediate step in the assembly thereof;

FIG. 34C is a cross-section of the rib of FIG. 34B in which the rib is assembled;

FIG. 35A is a cross-section of another embodiment of a rib of the invention showing an early step in the assembly thereof, drawn at a larger scale;

FIG. 35B is a cross-section of the rib of FIG. 35A showing an intermediate step in the assembly thereof;

FIG. 35C is a cross-section of the rib of FIG. 35B in which the rib is assembled;

FIG. 36A is a cross-section of another embodiment of a rib of the invention showing an early step in the assembly thereof, drawn at a smaller scale;

FIG. 36B is a cross-section of the rib of FIG. 36A showing an intermediate step in the assembly thereof;

FIG. 36C is a cross-section of the rib of FIG. 36B in which the rib is assembled;

FIG. 37A is a cross-section of another embodiment of a rib of the invention showing an early step in the assembly thereof;

FIG. 37B is a cross-section of the rib of FIG. 37A showing an intermediate step in the assembly thereof;

FIG. 37C is a cross-section of the rib of FIG. 37B in which the rib is assembled;

FIG. 38A is a cross-section of a sheath portion of another embodiment of a rib of the invention, drawn at a larger scale;

FIG. 38B is a cross-section of the sheath portion of FIG. 38A with a resistive element positioned therein;

FIG. 38C is a cross-section of the sheath portion and the resistive element of FIG. 38B with an insulator material positioned in the sheath portion;

FIG. 39A is a cross-section of a body portion of another embodiment of a rib of the invention and two insulator layers positioned adjacent thereto at an early step in the assembly thereof, drawn at a larger scale;

FIG. 39B is a cross-section of the body portion of FIG. 39A with the insulator layers attached thereto, the body portion being partially formed;

FIG. 39C is a cross-section of the body portion of FIG. 39B with a resistive element positioned adjacent to the insulator layers and the body portion partially formed to retain the resistive element, to form the rib;

FIG. 39D is a cross-section of the rib of FIG. 39C showing the body portion formed to provide a top surface for engaging the object;

FIG. 40 is a cross-section of another embodiment of the barbecue assembly of the invention, drawn at a smaller scale;

FIG. 41A is a cross-section of another alternative embodiment of the rib of the invention showing an early step in the assembly thereof, drawn at a larger scale;

FIG. 41B is a cross-section of the rib of FIG. 41A showing an intermediate step in the assembly thereof;

FIG. 41C is a cross-section of the rib of FIG. 41B in which the rib is assembled;

FIG. 41D is a cross-section of an alternative embodiment of the rib of the invention;

FIG. 42A is a cross-section of a pair of ribs of another embodiment of the invention, drawn at a smaller scale; and

FIG. 42B is a cross-section of a pair of ribs of another embodiment of the invention.

### DETAILED DESCRIPTION

In the present specification, unless the content specifically requires otherwise, when used as a verb the word “grill” is used to refer to the cooking of a food object wherein the food object is, at least in some regions or zones of the food object, in direct contact with a heated element or member (i.e., whereby the food object is heated by conduction), and may also include radiant heating in addition to direct contact with a heat source. When used as a noun, “grill” is used to refer to an article, apparatus or device which may be used to grill a food object and which may, in certain embodiments, also or alternatively be suitable for broiling.

In the present specification, unless the context specifically requires otherwise, the term “broil” is used to refer to the cooking of a food object wherein the food object is subject only to radiant heating, with substantially no heating of the food object by conduction.

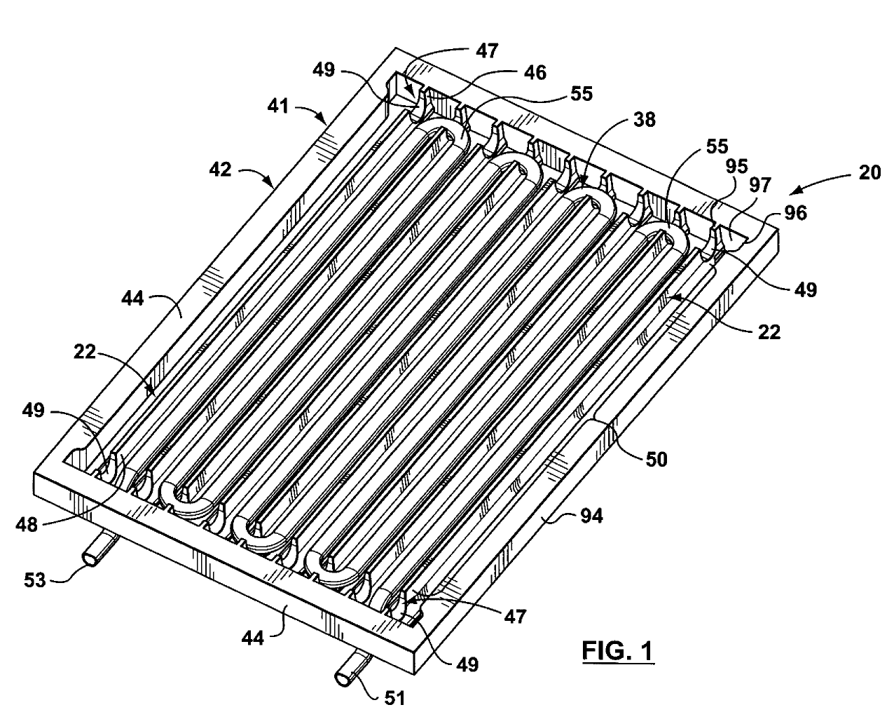

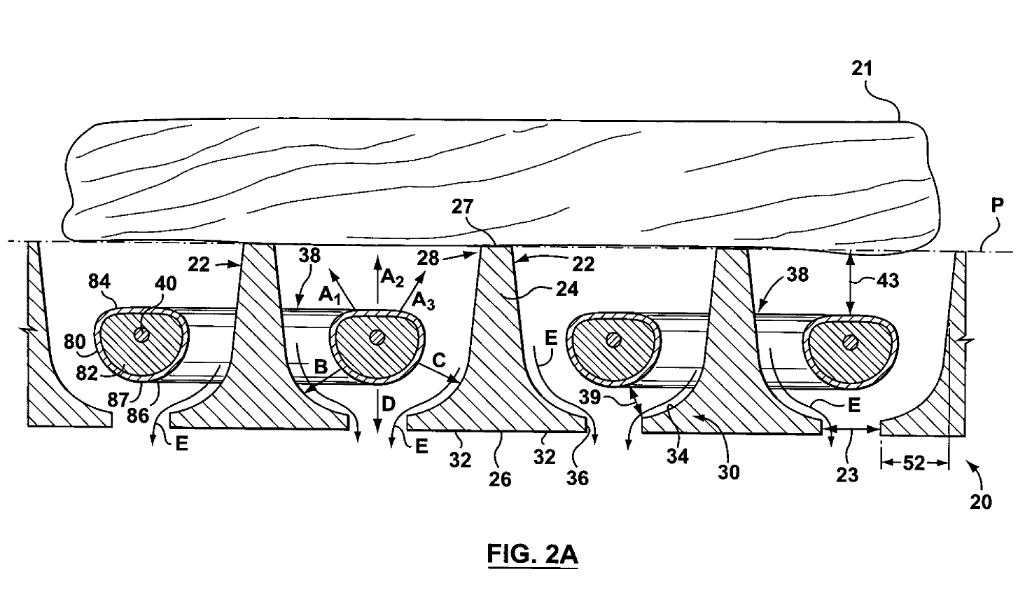

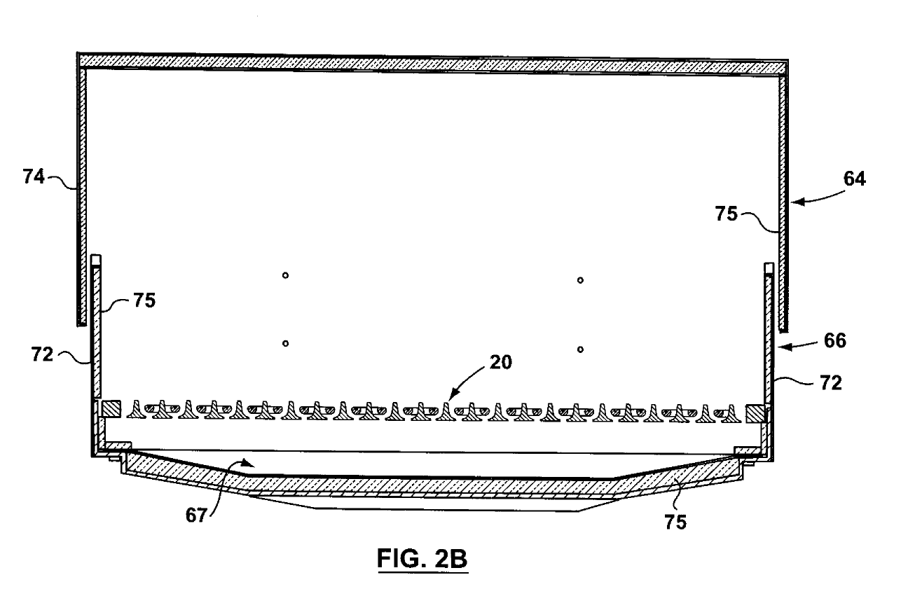

Reference is first made to FIGS. 1, 2A, and 2B to describe an embodiment of a barbecue grill in accordance with the invention indicated generally by the numeral 20. The barbecue grill 20 is for barbecuing an object 21 (FIG. 2A) which releases a liquid during barbecuing (i.e., cooking) thereof. The barbecue grill 20 comprises a number of elongate ribs 22 for supporting the object 21 which are spaced apart from each other by at least a first predetermined distance 23, as will be described. The barbecue grill 20 also includes one or more resistive element assemblies 38 for generating heat to barbecue the object positioned at a second predetermined distance 43 below the object 21 (FIG. 2A).

Preferably, the resistive element subassembly 38 is at least partially spaced apart from each rib 22 by a second predetermined distance 39 (at a minimum) to define a gap between the resistive element subassembly 38 and the adjacent rib 22, through which liquid from the barbecued object 21 moves under the influence of gravity.

It is preferred that the resistive element subassembly 38 includes an electrically resistive element 40 positioned inside a sheath 80. The resistive element 40 is electrically insulated from the sheath 80 by an electric insulator 82 disposed between the resistive element 40 and the sheath 80.

Sheathed elements are well known in the art, and it is therefore unnecessary to provide further details of the resistive element subassembly's construction, except as follows. In one embodiment, the sheath 80 is generally substantially circular in cross-section and the resistive element is coaxial with the sheath. However, it is also preferred that, in another embodiment, the sheath 80 is somewhat flattened in an upper side portion 84 thereof, so that the sheath 80 in the upper side portion 84 is proximal to the resistive element 40. As can be seen in FIG. 2A, it is preferred that a generally circular cross-section is formed by a lower side portion 86 of the sheath 80. Accordingly, the upper side portion 84 of the sheath 80 is closer to the resistive element 40 than the lower side portion 86 of the sheath 80. As a consequence of the asymmetrical cross-section configuration of the sheath 80, somewhat greater outward radiation of heat is provided from the upper side portion 84, such thermal radiation being directed generally upwardly (FIG. 2A), as will be described. Also, heat is radiated from the sheath 80 radially in substantially all directions, as will be described.

In one embodiment, each rib 22 includes a top surface 27 at a top end 28 of each rib 22 for supporting at least a portion of the object 21. Preferably, the top surfaces 27 substantially define a plane (designated as “P” in FIG. 2A). As shown in FIG. 2A, the resistive element subassembly 38 preferably is positioned the second predetermined distance 43 below the plane substantially defined by the top surfaces of the ribs 22 (FIG. 2A). Preferably, the second predetermined distance is so that the resistive element subassembly 38 is sufficiently close to the plane “P” to cook the object 21, however, without the subassembly 38 generally burning the object 21 due to direct thermal radiation.

As can be seen in FIG. 1, the barbecue grill 20 includes a grid portion 41 thereof having a frame 42 with one or more support members 44. The grid portion 41 also includes the ribs 22. Each rib 22 extends between a first end 46 and a second end 48 thereof, and the first and second ends 46, 48 are both attached to the support member 44. Preferably, and as shown in FIG. 1, the ribs 22 are positioned substantially parallel to each other.

FIG. 1 also shows that each rib 22 preferably includes vertically-oriented recesses 47 positioned at the first and second ends 46, 48. Each recess 47 is defined by a surface 49. Preferably, each surface 49 generally follows a portion of an arc formed to receive the lower side portion 86 of the sheath 80. In order to facilitate conduction of heat from the resistive element subassembly 38 to the rib 22, it is preferred that substantially the entire surface 49 engages an exterior surface 87 of the lower side portion 86 (FIG. 2A). Accordingly, the surface 49 preferably follows an arc curved in substantially the same way as the exterior surface 87 of the lower side portion 86 is curved, so that the surface 49 will generally closely fit with and engage the exterior surface 87 of the lower side portion 86.

Preferably, the resistive element subassembly 38 is continuous, extending from one end 51 thereof to another end 53 thereof. The ends 51, 53 are adapted for connection to a source of electrical power to the resistive element 40, as is known. The means for connecting the ends 51, 53 to the electrical power source are not illustrated as they are well known in the art. The resistive element subassembly 38 also preferably includes a plurality of corner portions 55. As shown in FIG. 1, the corner portions 55 are receivable in the recesses 47.

Preferably, the material out of which the grid portion 41 is made has a high heat tolerance, i.e., such material should be capable of withstanding temperatures of approximately 500° C. It is also preferred that the material of which the grid portion 41 is made has a reasonable ability to absorb heat through conduction and radiation. Finally, because of the need to scrape the grid portion 41 after use, it is also preferred that the grid portion 41 be made of material having sufficient durability to withstand repeated cleanings with metallic tools. The grid portion 41 may be made of any suitable material, e.g., cast iron, steel, or stainless steel. Also, those skilled in the art would appreciate that certain grades of aluminum which are relatively hard (e.g., aluminum grade 6061-T6) may be suitable.

As can be seen in FIGS. 1 and 2A, each rib 22 is adapted for receiving the object 21 on the top end 28 of the central portion 24 (and supporting the object 21), where the object 21 is heated by conduction of heat from the central portion 24, and by radiation of heat from the upper surface 34 of a ridge portion 30. Preferably, the upper surface 34 is configured to direct liquid released by the barbecued object toward an outer edge 36 thereof, as shown in FIG. 2A.

Preferably, one or more ridge portions 30 are positioned generally transverse to the central portion 24 and below the top end 28 of each rib 22. Each ridge portion 30 includes a lower surface 32 adjacent to a bottom end 26 of the central portion 24 and an upper surface 34 positioned above the lower surface 32. The outer edge 36 of the ridge portion 30 is positioned distal to the central portion 24 (FIG. 2A).

In order to facilitate more efficient heat transfer from the resistive element subassembly 38 to the central portion 24, the ridge portions 30 preferably are as thin as practicable. The ridge portions 30 should be sufficiently thick that they are durable, i.e. sufficiently substantial to withstand normal wear and tear.

Preferably, the gap 39 between the resistive element subassembly 38 and the ridge portion 30 is minimized, for more efficient heat transfer. However, the gap 39 should also be sufficiently large that grease (i.e., liquid) from the object 21 can pass through the gap 39, under the influence of gravity. Also, food particles typically fall off the object 21 from time to time, and it is preferred that the gap 39 be sufficiently large to permit most of such food particles to pass therethrough.

It is also preferred that the distance between adjacent ribs 22 should be minimized, in order to maximize the transfer of heat from the resistive element subassembly 38 to the ribs 22. However, the distance 23 between adjacent ribs 22 should also be sufficiently large to permit liquid (i.e., grease exiting the object 21 as it is cooked) and food particles to pass downwardly between adjacent ribs 22.

As can be seen in FIG. 1, the central portion 24 of each rib 22 includes a main segment 50 extending between the first and second ends 46, 48, and spaced apart from the first and second ends 46, 48. The ridge portions 30 of each rib 22 preferably extend laterally a preselected distance 52 from the central portion along the length of the main segment 50 (FIG. 2A).

The support members 44 preferably define a substantially rectangular or square frame 42, which (in one embodiment) include side support members 94 defining respective sides of the frame 42 (FIG. 1). Also, in this embodiment, the ribs 22 include terminal ribs 95 which are positioned adjacent to the respective side support members 94. Preferably, the outer edges of the ridge portions of the terminal ribs 95 are spaced apart from the side support members 94 by a distance which is about the same as the gap 23. As can be seen in FIG. 1, it is preferred that the side support members 94 include corresponding notches 96. Preferably, each of the notches 96 defines an opening 97 for permitting movement of liquid and food particles from the object therethrough by gravity. Primarily, the opening 97 is useful when the grill is cleaned (i.e., scraped) after use, as relatively larger food particles may be dislodged during cleaning.

However, most of the liquid and food particles fall between the ribs, i.e., the predetermined distance 23 has been found to be sufficiently large that most liquid and waste material from the object falls between the ribs. The openings 97 are useful primarily with respect to relatively large food particles which are dislodged when the grill is scraped to clean it after use. In one embodiment, the outer edge of each ridge portion 30 is spaced apart from each adjacent rib 22 by the predetermined distance 23 to permit drainage of the liquid from each upper surface 34 off the outer edge 36 thereof (FIG. 2A). The distance between adjacent ribs 22 should be minimized, in order to maximize the heat radiated onto the object 21. However, the distance 23 between adjacent ribs 22 should also be sufficiently large to permit liquid and food particles to pass downwardly between adjacent ribs 22. Preferably, each rib 22 extends about 0.5 inches between the top surface 27 and the bottom end 26. It has been determined that the optimal distance between adjacent ribs 22 is approximately 0.2 inches.

In use, the resistive element 40 generates heat when an electrical current is allowed to pass through the resistive element 40. Heat is transferred from the resistive element 40 through the electric insulator 82 by conduction, to cause the sheath 80 to become hot. As described above, the heat is radiated from the upper side portion 84 of the sheath 80 generally upwardly, i.e., generally toward the object 21 to be cooked, as schematically illustrated by arrows “A₁”, “A₂”, and “A₃” in FIG. 2A. However, heat also is radiated from the sheath 80 in other directions, as indicated by arrows “B”, “C”, and “D” in FIG. 2A. Accordingly, each rib 22 is heated, both by thermal radiation from the resistive element subassembly 38, and also through conduction, because the resistive element subassembly 38 is in direct contact with each rib 22 at the recess 47. Preferably, in order to facilitate heat transfer to the ribs 22 by thermal radiation, the ribs 22 are colored black. Heat is also transferred from the rib 22 to the object 21 by conduction at the top surface 27, where the object is in contact with the top surface. This results in lines of blackened or charred material (e.g., charred meat, if the object 21 is a piece of meat) in the object 21 where the object 21 contacts the top surface 27, which are generally desirable for showing that the object has been barbecued.

As can be seen in FIG. 2A, grease and other liquids released by the object 21 as it is barbecued move downwardly past the assembly 38, under the influence of gravity. The flow of such liquids due to gravity is schematically illustrated by arrows identified as “E” in FIG. 2A.

As shown in FIG. 2B, the barbecue grill 20 preferably is included in a barbecue assembly 64 which includes a housing 66 with a floor portion 67. The housing 66 also includes walls 72 extending upwardly from the floor portion 67 and an openable lid 74, all of which preferably are insulated (as will be described), to minimize heat loss. The lid 74 preferably is positioned in the housing 66 so that the lid 74 engages the walls 72 to form a generally air-tight seal when closed, as is known. Preferably, the barbecue grill 20 is mounted in the housing 66 at a position vertically spaced apart from the floor portion 67. Grease and other liquids released from the object 21 as the object is barbecued pass through the barbecue grill 20 and collect on the floor portion 67. As is known, the floor portion 67 is formed to direct liquids accumulated thereon to a drain (not shown in FIG. 2B) through which the liquids exit the housing 66.

As can also be seen in FIG. 2B, the housing 66 preferably includes one or more insulating components 75 which are included in the floor 67, the walls 72, and the lid 74. The insulating component 75 may be any suitable material or structure, as would be known by one skilled in the art. However, it is preferred that the insulating component be an air gap (not shown), i.e., an enclosed space defined by a double-walled construction in which “dead” air provides the insulating effect. As a double-walled structure is well known in the art, it is not necessary to provide any further description of this construction.

As can be seen in FIG. 2A, by positioning the resistive element subassembly 38 relatively close to the object 21 (i.e., relatively close to the plane “P”), the radiation view factor of the resistive element subassembly 38 with respect to the object 21 is very favorable. The preferred distance 43 is approximately 0.2 inches. Also, because of the positioning of the resistive element subassembly 38 relatively proximal to the object 21, much more thermal radiation is received by the object 21 than would be the case if the resistive element subassembly 38 were positioned further away from the object 21, as is the case in the prior art. It will be appreciated by those skilled in the art that the appropriate balance is required to be found between the amount of thermal radiation provided to the object 21 and the amount of heat transferred to the object 21 by conduction, i.e., at the contact between the object 21 and the top surfaces 27 of the ribs. Preferably, sufficient heat is transferred to the object 21 via conduction from the ribs 22 that charred (black) grill markings are developed on the object within a predetermined time period. Also, it is preferred that, within approximately the same time period, sufficient heat is transferred to the object 21 via thermal radiation to cook the object to a desired extent.

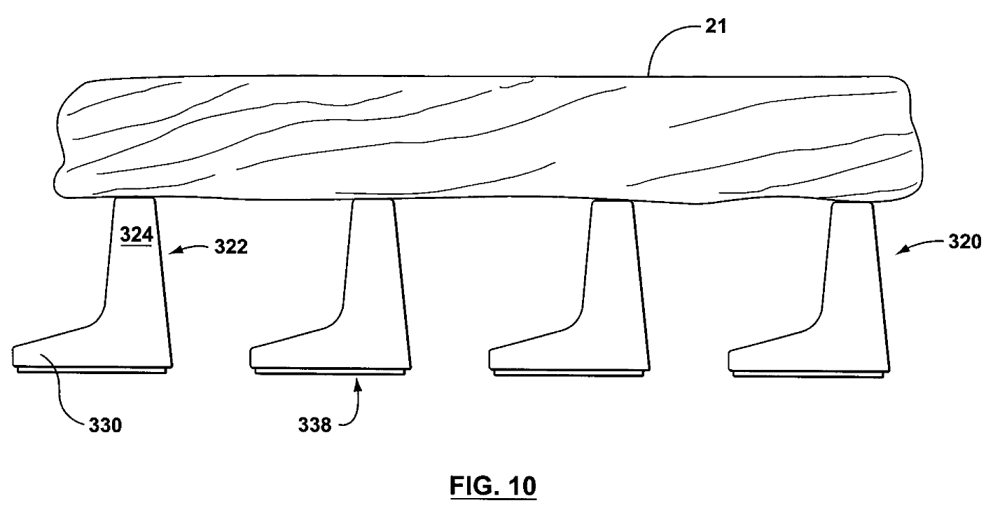

It will be understood that, although the ribs 22 as illustrated are generally in the shape of an inverted “T”, the ribs 22 may have any suitable configuration or form. For example, FIG. 10 illustrates ribs having an alternate structure, as will be described.

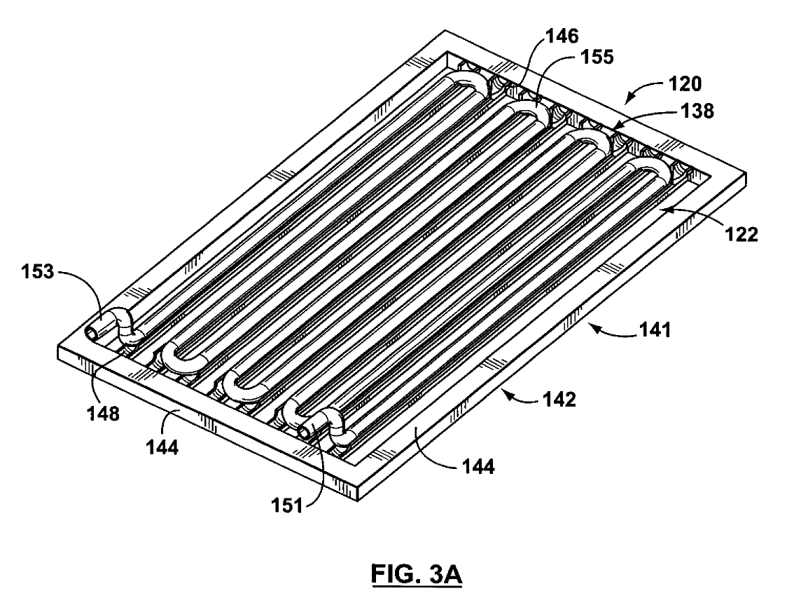

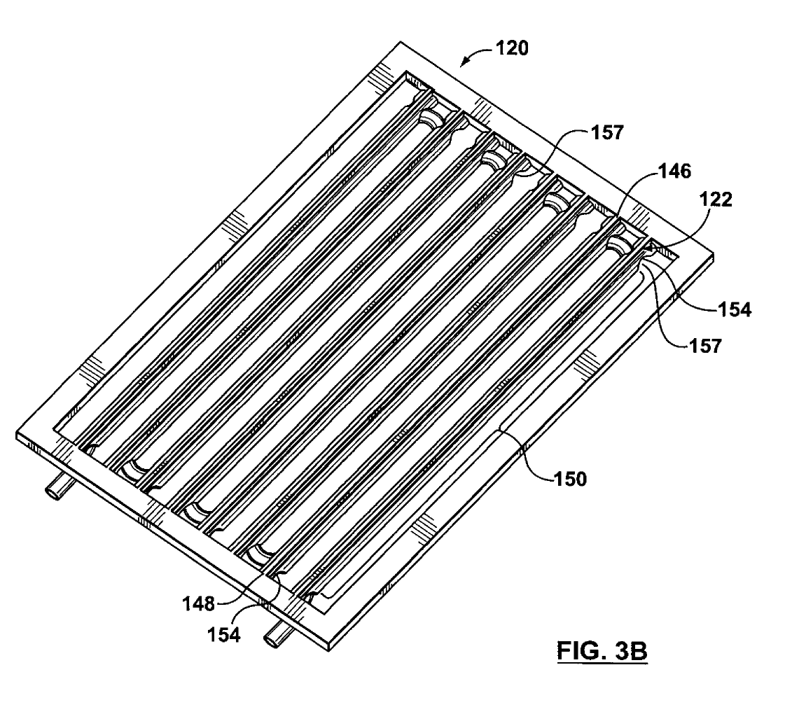

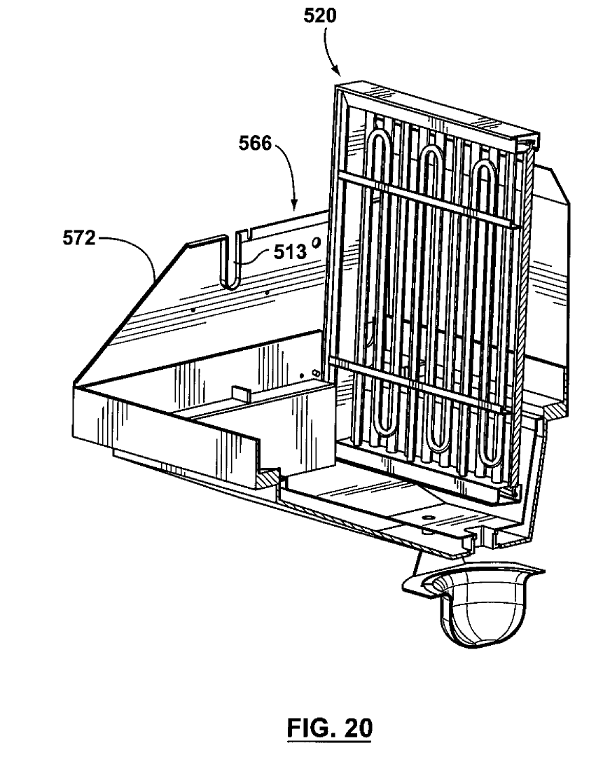

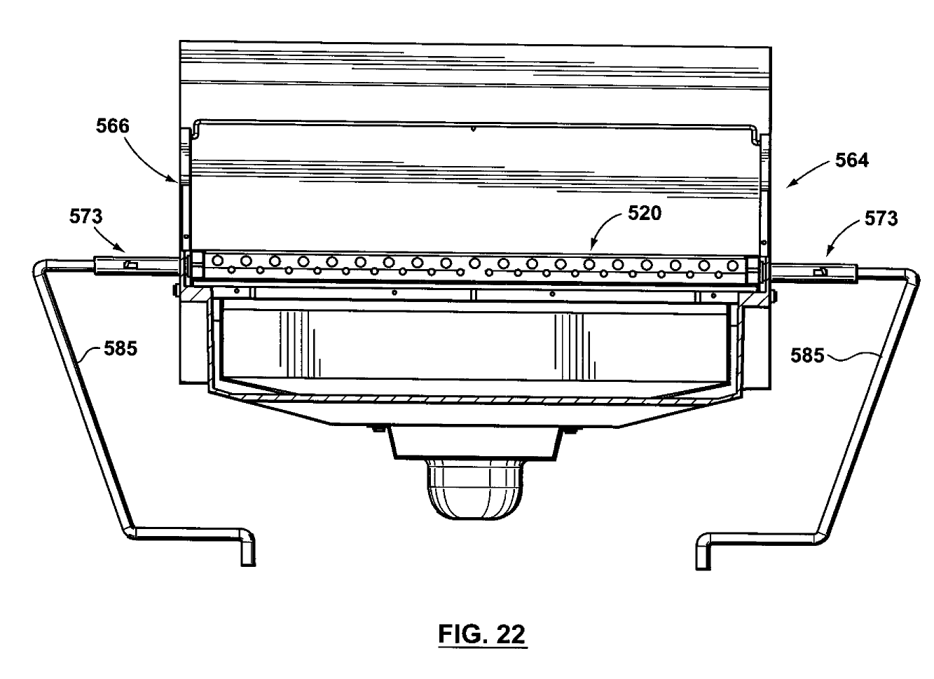

Additional embodiments of the invention are shown in FIGS. 3A-42B. In FIGS. 3A-42B, elements are numbered so as to correspond to like elements shown in FIGS. 1, 2A, and 2B.

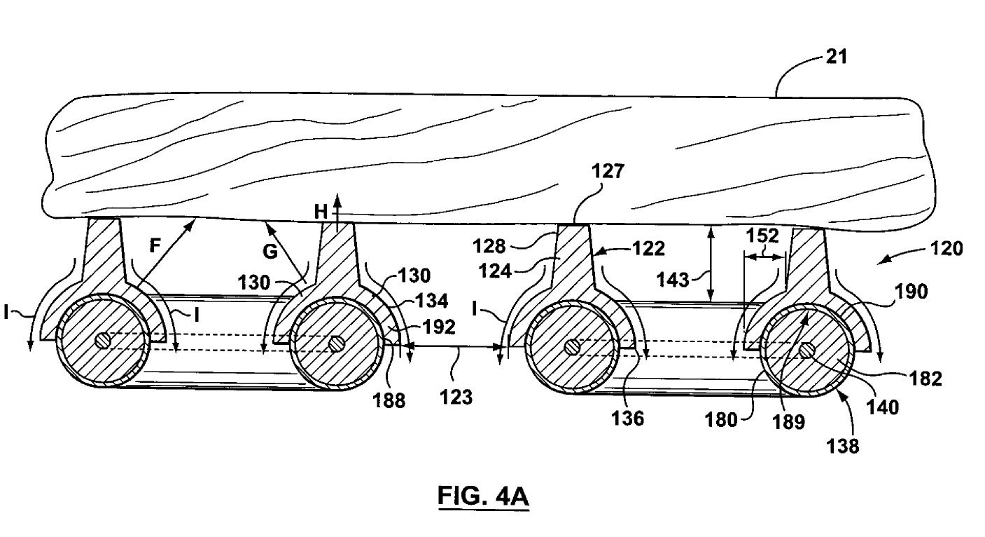

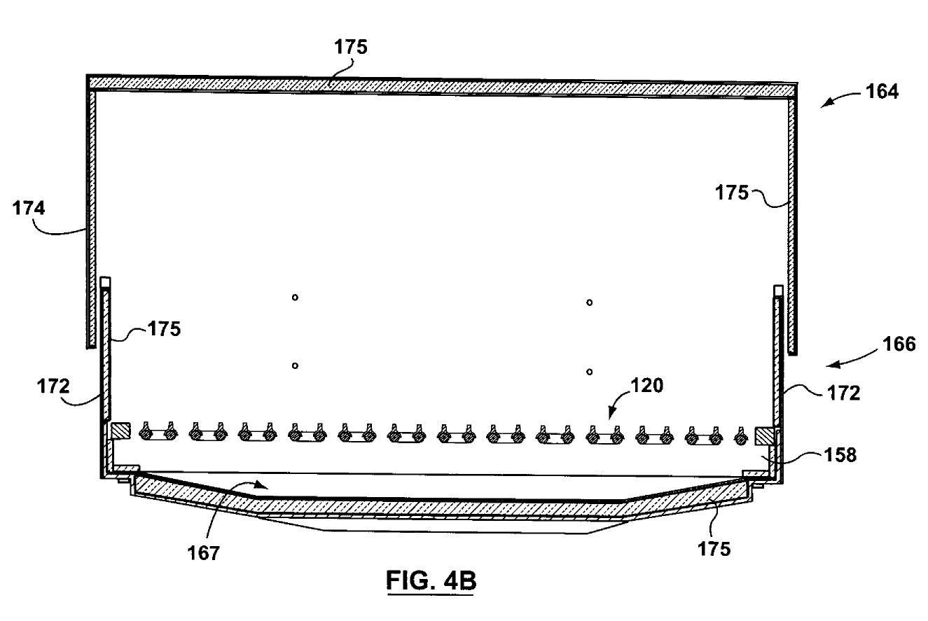

Another embodiment of the barbecue grill 120 of the invention is shown in FIGS. 3A, 3B, 4A, and 4B. The barbecue grill 120 includes a number of ribs 122 for supporting the object 21 spaced apart from each other by at least a first predetermined distance 123. The barbecue grill 120 also includes one or more resistive element subassemblies 138 positioned at least partially under the ribs 122, as will be described. Preferably, the grill 120 includes one resistive element subassembly 138. As will be described, the resistive element subassembly 138 is for generating heat to barbecue the object 21. Each rib 122 includes a contact surface 188 with which the resistive element subassembly 138 engages, for conduction of heat generated by the resistive element subassembly 138 into each rib 122.

It is preferred that the resistive element subassembly 138 includes a resistive element 140 positioned inside a sheath 180. An electric insulator 182 is positioned between the resistive element 140 and the sheath 180, to prevent electric current from passing directly from the resistive element 140 to the sheath 180, as is known.

Preferably, the sheath 180 includes a mating portion 189 with an outer surface 190 shaped for engagement with the contact surface 188. It is preferred that the outer surface 190 engages the contact surface 188 generally, for conduction of heat generated by the resistive element 140 from the sheath 180 to the contact surface 188. FIG. 3A shows ribs 122 with the resistive element subassembly 138 positioned on the contact surface 188, but it also shows contact surfaces 188 in which the resistive element subassembly is not positioned. As shown in FIGS. 3A and 4A, the contact surface 188 preferably substantially defines a semi-circle (or defines an arc describing a part of a circle, as the case may be), and the outer surface 190 is also substantially semi-circular (or defines an arc describing a part of a circle, as the case may be), and formed to fit with the contact surface 188.

As can be seen in FIG. 4A, each rib 122 includes a central portion 124 extending from the contact surface 188 to a top surface 127 at a top end 128 thereof. Each rib 122 also includes ridge portions 130 extending generally transversely from the central portion 124. As can be seen in FIG. 4A, each ridge portion 130 includes an upper surface 134 which generally faces upwardly and toward an adjacent rib.

In order to facilitate more efficient heat transfer from the contact surface 188 to the upper surface 134, body segments 192 of the ridge portions 130 preferably are as thin as practicable. The body segments 192 should be sufficiently thick to provide for durable ridge portions 130, i.e., ridge portions which are sufficiently substantial to withstand cleaning after use of the barbecue grill 120. However, the thinner the ridge portion 130, the more efficiently heat may be transferred via the ridge portion 130, i.e., from the contact surface to the upper surfaces. Accordingly, each upper surface 134 is preferably positioned proximal to the contact surface 188 in each rib 122.

From the foregoing, it can be seen that heat is both conducted to the top surface 127 from the resistive element subassembly 138, and heat is also radiated generally upwardly from the upper surfaces 134.

As can be seen in FIGS. 3A and 3B, the barbecue grill 120 includes a grid portion 141 thereof having a frame 142 with one or more support members 144. The grid portion 141 also includes the ribs 122. Each rib 122 extends between a first end 146 and a second end 148 thereof, both of which are attached to the support member 144. Preferably, the ribs 122 are positioned substantially parallel to each other.

As can also be seen in FIGS. 3A and 3B, each rib 122 is adapted for receiving the object 21 on the top end 128 of the central portion 124, and for heating the object 21 by both conduction of heat from the central portion 124 and radiation of heat from the upper surface 134 of the ridge portion 130. Preferably, the upper surface 134 is configured to direct the liquid released by the barbecued object toward an outer edge 136 thereof, as shown in FIG. 4A. The outer edge 136 is disposed distal to the central portion 124.

As can be seen in FIG. 4A, the resistive element subassembly 138 is preferably positioned a predetermined distance 143 below the object. A larger (e.g., taller) central portion 124 of each rib 122 tends to decrease the amount of heat available at the top end 128 for transfer to the object 21, i.e., to cook the object 21. Also, the extent of radiated heat to which the object 21 is subjected is substantially reduced where the distance 143 is larger. The predetermined distance 143 should be large enough that the object 21 is not generally burned, but small enough that the object 21 receives sufficient heat to cook it.

As can be seen in FIGS. 3B and 4A, the ridge portions 130 extend laterally from the central portion 124. Preferably, each rib 122 is formed as an integral body which includes the central portion 124 and the ridge portions 130, integrally joined together.

In one embodiment, the outer edge 136 of each ridge portion 130 is spaced apart from each rib 122 which is adjacent thereto by the predetermined distance 123 to permit drainage of the liquid from each upper surface 134 at the outer edge 136 thereof (FIG. 4A). The distance 123 between adjacent ribs 122 should be minimized, in order to maximize the heat radiated onto the object 21. However, the distance between adjacent ribs 122 should also be sufficiently large to permit liquid and food particles to pass downwardly between adjacent ribs 122. It has been determined that the optimal distance between adjacent ribs 122 is approximately 0.2 inches.

As can be seen in FIG. 3B, the central portion 124 of each rib 122 includes a main segment 150 extending between the first and second ends 146, 148, and spaced apart from the first and second ends 146, 148. The ridge portions 130 of each rib 122 preferably extend laterally a preselected distance 152 from the central portion along the length of the main segment 150. It is also preferred that each rib 122 includes one or more notches 154 defining an opening 157 (FIG. 3B) for permitting movement of liquid and food particles from the object therethrough by gravity.

The notches 154 are sized and located so that the opening 157 defined thereby permits liquids and waste materials (i.e., food particles) from the object which are scraped off or otherwise directed by the rib (e.g., when the ribs are cleaned, after use) to fall into a space 158 provided beneath the barbecue grill 120 (FIG. 4B).

As described above, it will be understood that most of the liquid and food particles from the object falls between the ribs. The opening 157 is useful primarily in connection with disposal of the food particles scraped from the ribs during cleaning thereof.

Preferably, the resistive element subassembly 138 is continuous, extending from one end 151 thereof to another end 153 thereof. The ends 151, 153 are adapted for connection to a source of electrical power to the resistive element 140, as is known. The means for connecting the ends 151, 153 to the electrical power source are not illustrated, as they are well known in the art. The resistive element subassembly 138 also preferably includes a plurality of corner portions 155 (FIG. 3A).

As can be seen in FIGS. 3A and 3B, the notches 154 preferably are positioned to accommodate the corner portions 155 of the resistive element subassembly 138. At those locations where the corner portion 155 extends between ribs, the resistive element subassembly 138 occupies the openings defined by the notches 154. Accordingly, in the grill 120, the notches 154 are generally located a relatively small distance inwardly from the first and second ends 146, 148.

Preferably, the material out of which the grid portion 141 is made has a high heat tolerance, i.e., such material should be capable of withstanding temperatures of approximately 600° C. It is also preferred that the material of which the grid portion 141 is made has a reasonable ability to absorb heat through conduction and convection, as will be described. Because of the need to scrape the grid portion 141 after use, it is also preferred that the grid portion 141 be made of material having sufficient durability to withstand repeated cleanings with metallic tools. Finally, the material should be a material to which a porcelain coating would adhere. The grid portion 141 may be made of any suitable material, e.g., cast iron, steel, or stainless steel. Also, those skilled in the art would appreciate that certain grades of aluminum which are relatively hard (e.g., aluminum grade 6061-T6) may be suitable.

In use, the resistive element 140 generates heat when an electrical current passes through the resistive element 140. Heat is conducted from the resistive element 140 through the electrical insulator 182 to cause the sheath 180 to become hot. As described above, heat is conducted from the mating portion 189 through the outer surface 190 thereof to the contact surface 188 of each rib 122. As schematically illustrated by arrows “F” and “G” in FIG. 4A, heat is radiated from the upper surfaces 134 of the ridge portions 130 to cook the object 21. Also, heat is conducted through the central portion 124 to the top surface 127 (as illustrated by arrow “H” in FIG. 4A), to be conducted to the object 21 (i.e., where the object 21 is in contact with the top surface 127), and to provide charred (black) grill markings on the object 21.

As a practical matter, it is unlikely that a “perfect” (or substantially perfect) mate between the outer surface 190 of the mating portion 189 of each sheath 180 and the contact surface 188 of each rib 122 is achieved. Instead, it is anticipated that there will occasionally be very small gaps (not shown) present (i.e., in barbecue grills constructed in accordance with this embodiment of the present invention) between the outer surface 190 of the mating portion 189 of the sheath 180 and the contact surface 188 of the rib 122. It will be understood that, although the resultant gaps between the outer surface 190 and the contact surface 188 would typically be relatively small, the contact surface 188 (and, as a result, the central portion 124) are, to an extent, heated by convection from the outer surface 190 where such gaps exist, as well as by conduction where there is direct contact. Accordingly, in practice, heat is transferred to the rib 122 via conduction and convection.

As can be seen in FIG. 4A, grease and other liquids released by the object 21 as it is barbecued move downwardly past the ribs 122, under the influence of gravity. The flow of such liquids due to gravity is schematically illustrated by arrows “I” in FIG. 4A.

As shown in FIG. 4B, the barbecue grill 120 preferably is included in a barbecue assembly 164 which includes a housing 166 with a floor portion 167. The housing 166 also includes walls 172 extending upwardly from the floor portion 167 and an openable lid 174 which preferably are insulated, to minimize heat loss. The lid 174 preferably is positioned on the walls 172 a distance above the floor portion 167, as is known. Preferably, the barbecue grill 120 is mounted in the housing 166 at a position vertically spaced apart from the floor portion 167. Grease and other liquids released from the object 21 as the object is barbecued pass through the barbecue grill 120 and are collected on the floor portion 167. As is known, the floor portion 167 is formed to direct liquids accumulated thereon to a drain (not shown in FIG. 4B) through which the liquids exit the housing 166.

As can be seen in FIG. 4B, the housing 166 preferably includes one or more insulating components 175 included in the floor 167, the walls 172, and the lid 174. The insulating component 175 may be any suitable material or structure, as would be known by one skilled in the art. However, it is preferred that the insulating component be an air gap (not shown), i.e., an enclosed space defined by a double-walled construction in which “dead” air provides the insulating effect.

It will be appreciated by those skilled in the art that, where the sheath portion (e.g., sheath 180) of the resistive element subassembly (i.e., the sheathed element) is substantially circular in cross-section, manufacturing costs therefor are somewhat lower than those incurred in manufacturing a sheathed element in which the cross-section of the sheath is not substantially circular (e.g., the sheath 80 in the resistive element subassembly 38).

Reference is next made to FIGS. 5-9 to describe another embodiment of a barbecue grill in accordance with the invention indicated generally by the numeral 220. As can be seen in FIGS. 5-7, the barbecue grill 220 includes a number of elongate ribs 222 for supporting the object 21. Each rib 222 includes an elongate central portion 224 extending substantially vertically between a bottom end 226 and a top end 228 (FIG. 8). Preferably, the rib 222 includes one or more ridge portions 230 positioned generally transverse to the central portion 224 and below the top end 228. The ridge portion 230 includes a lower surface 232 adjacent to the bottom end 226 and an upper surface 234 positioned above the lower surface 232. Preferably, the upper surface 234 extends between the central portion 224 and an outer edge 236 of the ridge portion 230 which is positioned distal to the central portion 224 (FIG. 8).

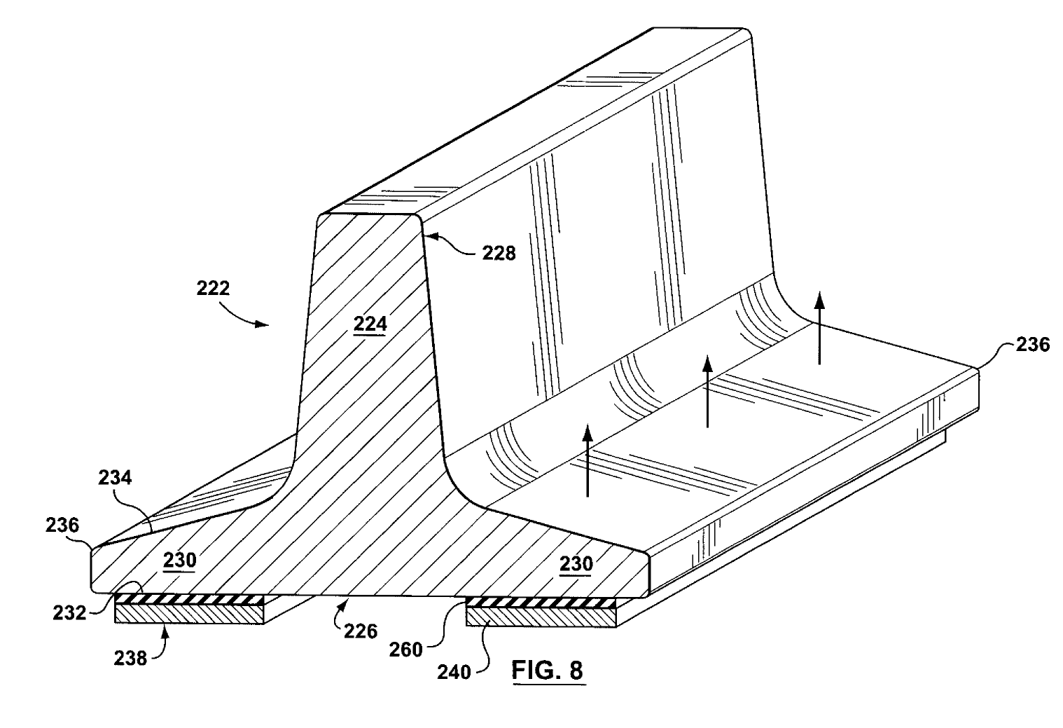

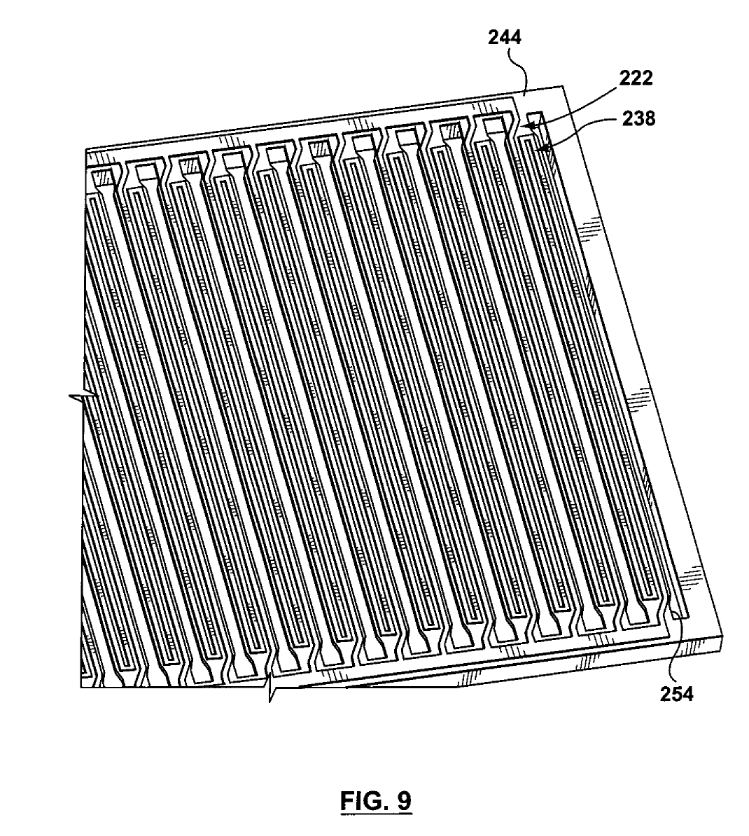

The rib 222 preferably also includes a resistive element subassembly 238 (FIGS. 8 and 9) having a resistive element 240 for generating heat upon electric current passing therethrough. It is also preferred that the resistive element 240 is adapted for connection to an electrical power source (not shown), as is known in the art. The resistive element subassembly 238 preferably is secured to the bottom end 226, the lower surface 232, or combinations thereof. Each rib 222 is adapted for receiving the object 21 on the top end 228 of the central portion 224, and for heating the object to be barbecued by conduction of heat from the central portion and by radiation of heat from the upper surface 234 of the ridge portion 230, as will be described. Preferably, the upper surface 234 of the ridge portion 230 is configured to direct the liquid released by the barbecued object toward the outer edge 236, as will also be described.

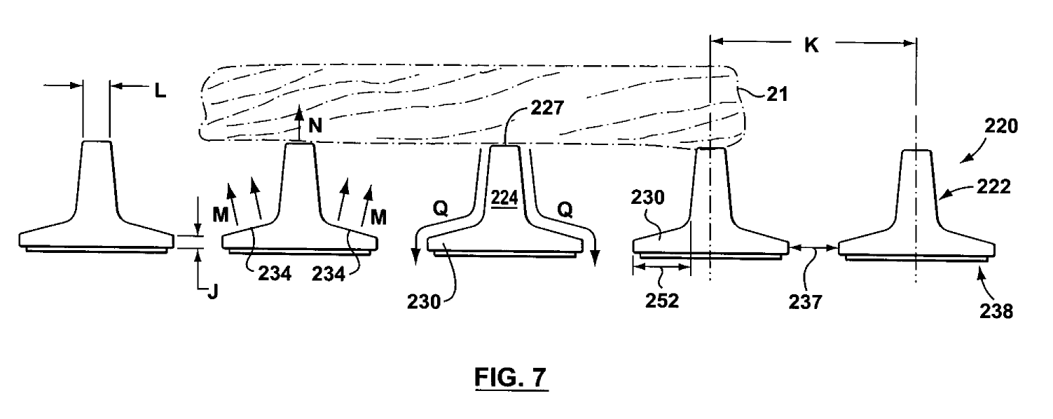

As can be seen in FIG. 7, the ridge portion 230 extends laterally from the central portion 224. It is also preferred that each rib 222 is formed as an integral body which includes the central portion 224 and the ridge portion 230, integrally joined together.

In one embodiment, the outer edge 236 of each ridge portion 230 is spaced apart from each rib 222 which is adjacent thereto by a predetermined distance 237 to permit drainage of the liquid from each upper surface 234 at the outer edge 236 thereof (FIG. 7). The distance 237 should be minimized, in order to maximize the heat radiated onto the object being barbecued. However, this distance should also be sufficiently large to permit liquid and food particles to pass downwardly between the ribs 222. It has been determined that the optimal distance 237 is approximately 0.2 inches.

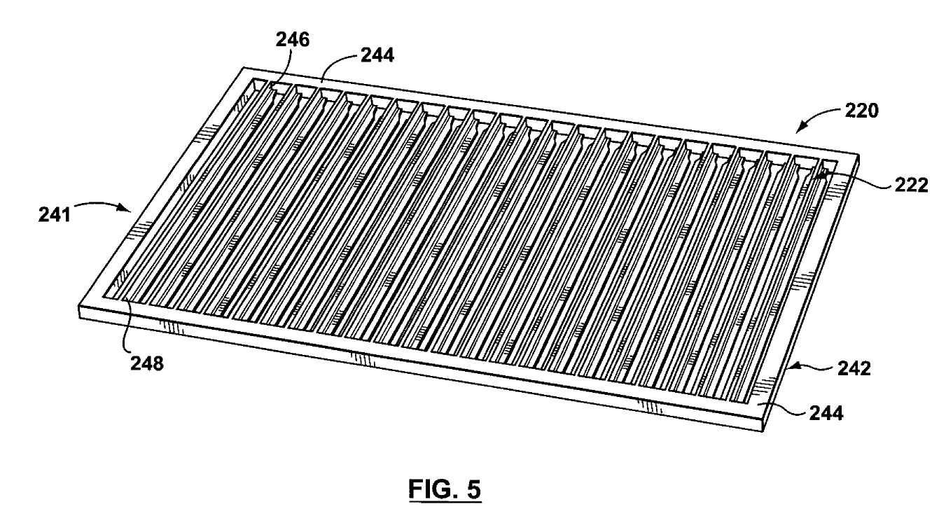

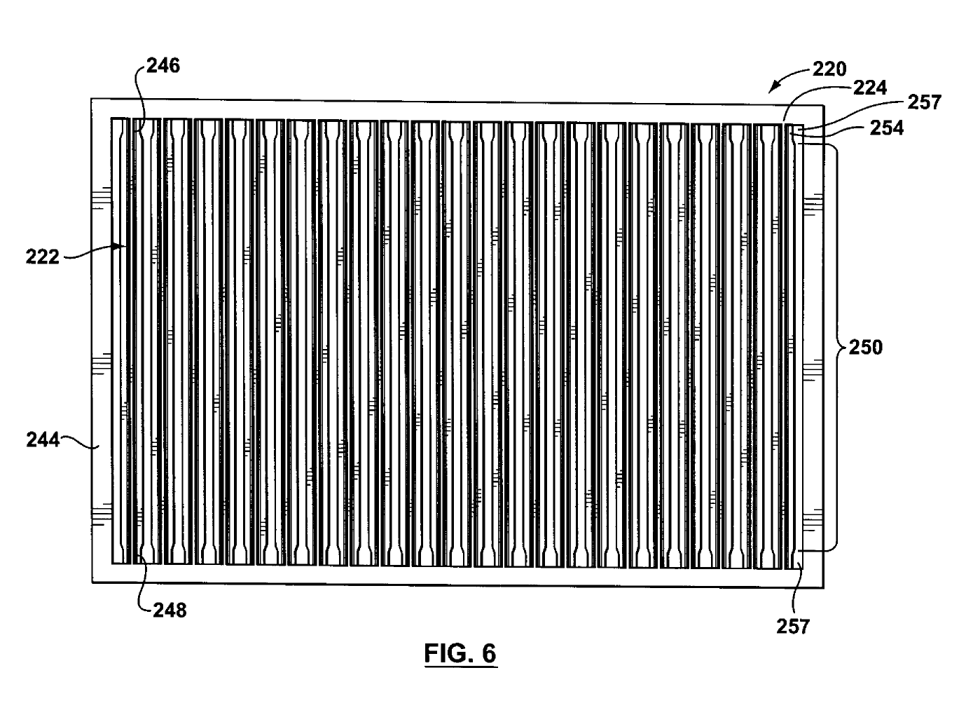

As can be seen in FIGS. 5 and 6, the barbecue grill 220 preferably includes a grid portion 241 having a frame 242 with one or more support members 244. Each rib 222 extends between a first end 246 and a second end 248 thereof. Preferably, the first end 246 and the second end 248 are both attached to the support member 244 (FIG. 6). It is also preferred that the ribs 222 are positioned substantially parallel to each other (FIG. 5).

As shown in FIG. 6, the central portion 224 of each rib 222 includes a main segment 250 extending between the first and second ends 246, 248, and spaced apart from the first and second ends 246, 248. The ridge portion 230 of each rib 222 preferably extends laterally a preselected distance 252 (FIG. 7) from the central portion 224 along the length of the main segment 250. It is also preferred that each rib includes one or more notches 254 defining an opening 257 (FIG. 6).

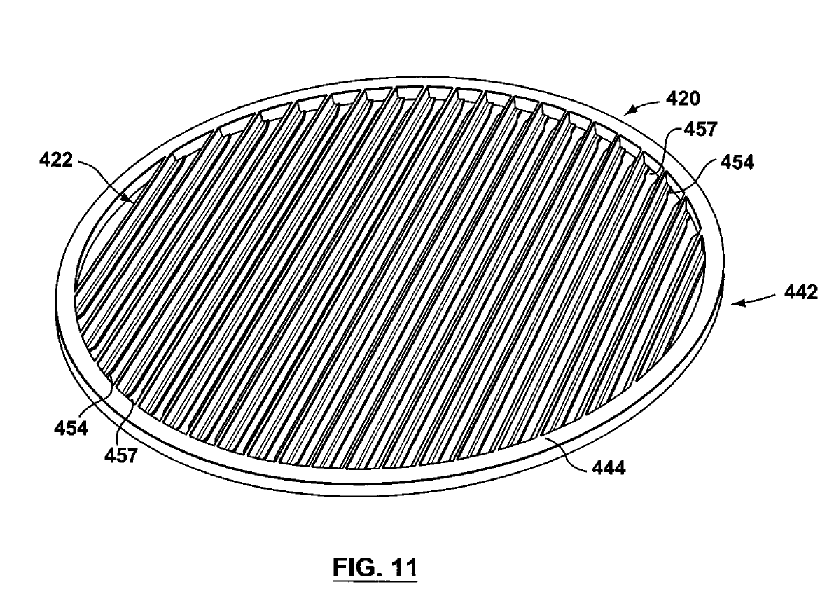

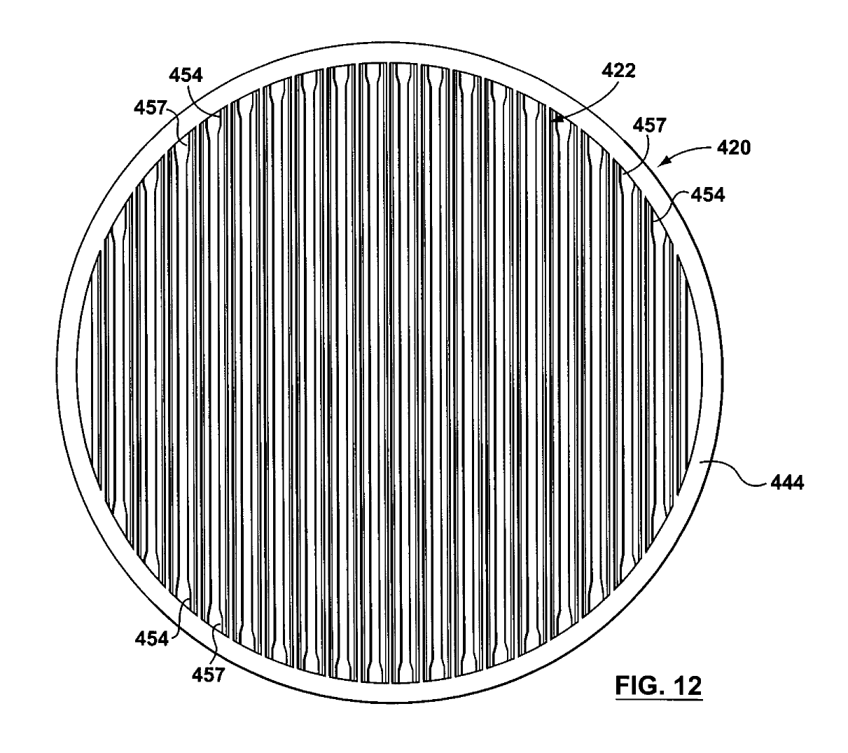

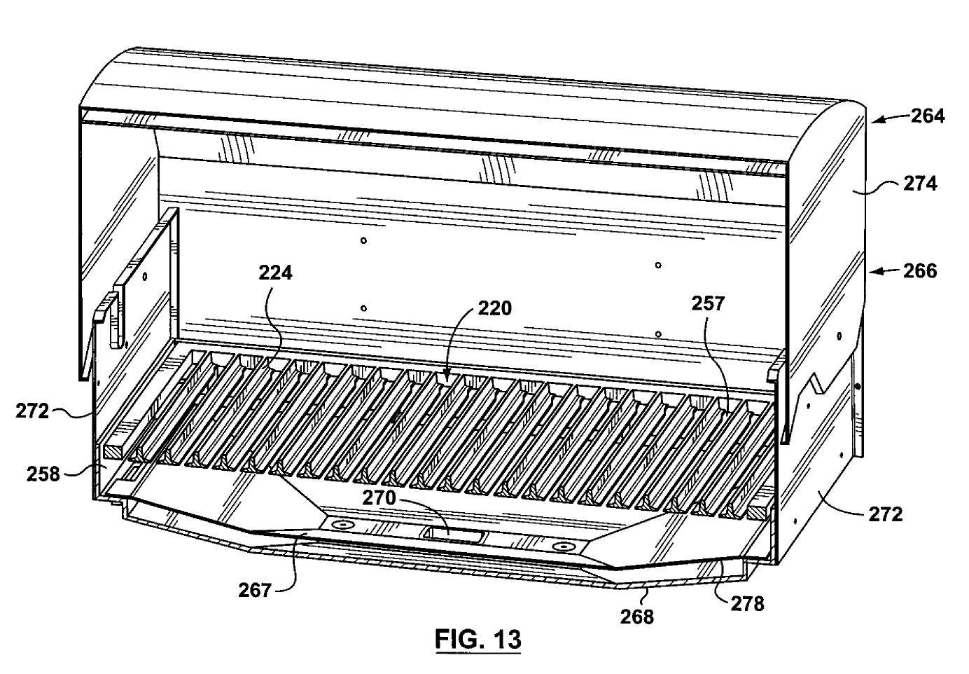

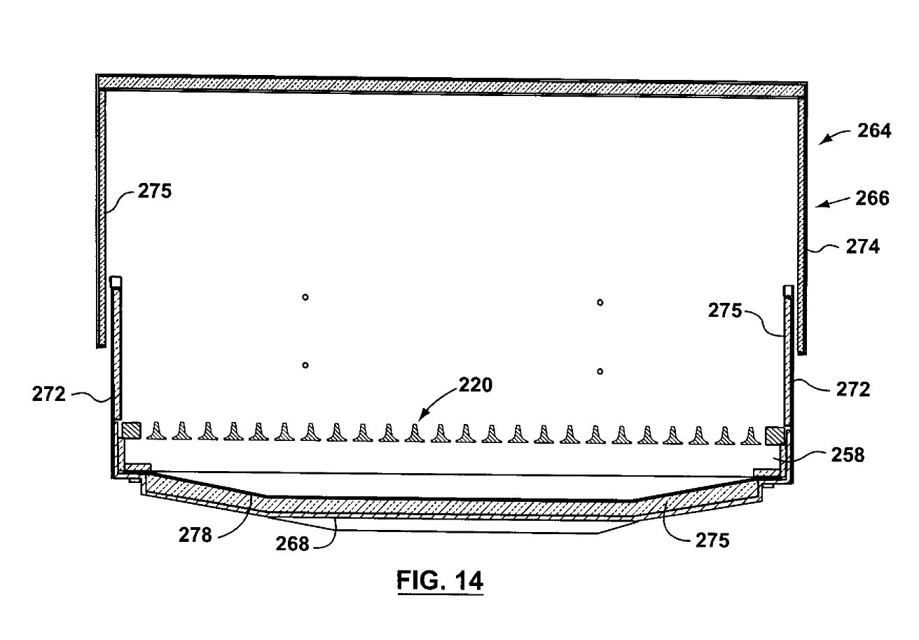

The notch segments 254 are sized and located so that the opening 257 defined thereby permits liquids and waste materials (i.e., food particles) from the object which are scraped off or otherwise directed by the rib to fall into a space 258 provided beneath the barbecue grill 220 (FIGS. 13, 14).

Preferably, the resistive element subassembly 238 includes a layer 260 of dielectric material for substantially electrically isolating the resistive element 240 from the ridge portion 230 and the central portion 224. As shown in FIG. 8, in one embodiment, the layer 260 is attached to the lower surfaces 232 of ridge portions 230. As can be seen in FIG. 9, the resistive element subassembly 238 may also be attached to the bottom end 226 of the central portion 224 as well as the lower surfaces 232 of the ridge portions 230. It will be appreciated by those skilled in the art that the resistive element subassembly 238 could also be attached only to the bottom end 226 of the central portion 224. Preferably, the resistive element subassembly 238 is continuous, extending from one end of the grid portion 241 to another (FIG. 9).

As can be seen in FIGS. 7 and 8, the upper surface 234 of the ridge portion 230 preferably is substantially planar. The upper surface 234 is also preferably positioned at a predetermined angle to the horizontal. Preferably, the predetermined angle is approximately 15°.

It will be appreciated by those skilled in the art that the ridge portion 230 preferably is formed to have a minimum thickness. For example, the minimum thickness of the ridge portion 230 is designated as “J” in FIG. 7. It will be understood by those skilled in the art that the minimum thickness of the ridge portion 230 is subject to certain constraints. To promote heat transfer through the ridge portion 230 from the lower surface 232 to the upper surface 234 (i.e., so that the maximum amount of heat is radiated from the upper surface 234), the ridge portion 230 generally should be as thin as possible. On the other hand, however, the ridge portion 230 needs to have sufficient thickness to enable it to withstand the loads to which it is subjected, to maintain structural integrity. For instance, if the rib were made of cast iron, then the distance J may be at least 0.05 inches, at a minimum.

Preferably, the material out of which the grid portion 241 is made has a similar thermal expansion rate as the resistive element subassembly 238. It is also important that the layer 260 be capable of adhering generally to the material. The material also preferably has a high heat tolerance, to enable it to withstand temperatures upwards of 600° C. The material preferably also should have a relatively good ability to conduct heat therethrough. Also, because of the need to scrape the grid portion 241 after use (i.e., to clean it), it is preferred that the grid portion 241 be made of material having sufficient durability to withstand repeated cleanings with metallic tools. In addition, the material out of which the grid portion is made should preferably be capable of receiving a porcelain coating, i.e., so that the porcelain coating generally can adhere to the material. The grid portion 241 may be made of any suitable material, e.g., cast iron. Also, those skilled in the art would appreciate that certain grades of aluminium which are relatively hard (e.g., aluminum grade 6061-T6) may be suitable.

In one embodiment, the lower surface of the ridge portion 230 is positioned approximately 0.4 inches below the top end of the central portion thereof, and the ridge portion has a minimum thickness of approximately 0.05 inches.

The preferred distance between the centers of the ribs (designated as “K” in FIG. 7) may vary between approximately 0.5 inch and about one inch. More preferably, such distance is approximately 0.8 inch.

The width of the top end (designated as “L” in FIG. 7) is preferably kept to a minimum in order to minimize the mass of the central portion which is required to be heated. However, the top end is subjected to cleaning (usually scraping with metal bristles or a metal tool), and a certain amount of width is required for structural integrity. Accordingly, the width of the top end is preferably approximately 0.1 inch.

As can be seen in FIGS. 7 and 8, the sides of the central portion preferably are sloped, for ease of manufacturing. Preferably, the sides are at approximately 6° from the vertical.

As shown in FIG. 7, heat (represented by arrows “M”) is radiated from the upper surface generally upwardly, to assist in barbecuing the object to be barbecued. At the same time, heat (represented by arrow “N”) is conducted from the top end to the object to be barbecued. Liquid from the object flows under the influence of gravity, as represented by arrows “Q” in FIG. 7.

As can be seen in FIGS. 13 and 14, a barbecue assembly 264 includes the barbecue grill 220 and a housing 266. The housing 266 preferably includes a floor portion 267 with a drain 270 (FIG. 13) to permit drainage of the liquid and one or more walls 272 for supporting the barbecue grill 220 a predetermined height above the floor portion 267. Preferably, the housing 266 also includes a movable lid 274 adapted to cooperate with the walls 272 for retarding heat transfer out of the housing 266. Also, the floor portion 267 preferably includes a floor 268 and a liner 278 mounted on the floor 268 and configured for channelling the liquid toward the drain 270.

In one embodiment, one or more portions of the housing 266 includes one or more insulating components 275 for retarding heat transfer out of the housing. The insulating component 275 may be any suitable material or structure, as would be known by one skilled in the art. However, it is preferred that the insulating component be an air gap (not shown).

As can be seen in FIG. 14, the bottom of the grill 220 preferably is positioned relatively close to the liner 278. Preferably, the volume of space between the bottom of the barbecue grill 220 and the liner 278 is minimized, in order that the barbecue assembly 264 may have maximum efficiency, i.e., to minimize the extent of heat loss. Preferably, the liner is positioned not more than approximately three inches below the ribs.

An alternative embodiment of a barbecue grill 320 of the invention including ribs 322 is disclosed in FIG. 10. Each rib 322 includes a central portion 324 and a single ridge portion 330. Preferably, each rib 322 has a portion of a resistive element subassembly 338 mounted on a bottom surface thereof. As shown in FIG. 10, it is preferred that the ribs 322 in a barbecue grill 320 including the ribs 322 are all oriented in the same way, i.e., with the ridge portions 330 on the same side of each central portion 324 respectively.

Another alternative embodiment of a barbecue grill 420 is shown in FIGS. 11 and 12. The barbecue grill 420 includes a frame 442 in which the support member 444 is generally circular in shape. Because of this, the ribs 422 in the barbecue grill 420 are of varying lengths. Preferably, a resistive element subassembly (not shown) similar to that shown in FIG. 8 is mounted on the bottom surfaces of the ribs 422.

As can be seen in FIGS. 11 and 12, the ribs 422 preferably include notches 454 defining openings 457 respectively, for permitting movement of liquid and food particles from the object (i.e., particularly food particles dislodged during cleaning of the grill 420) therethrough by gravity.

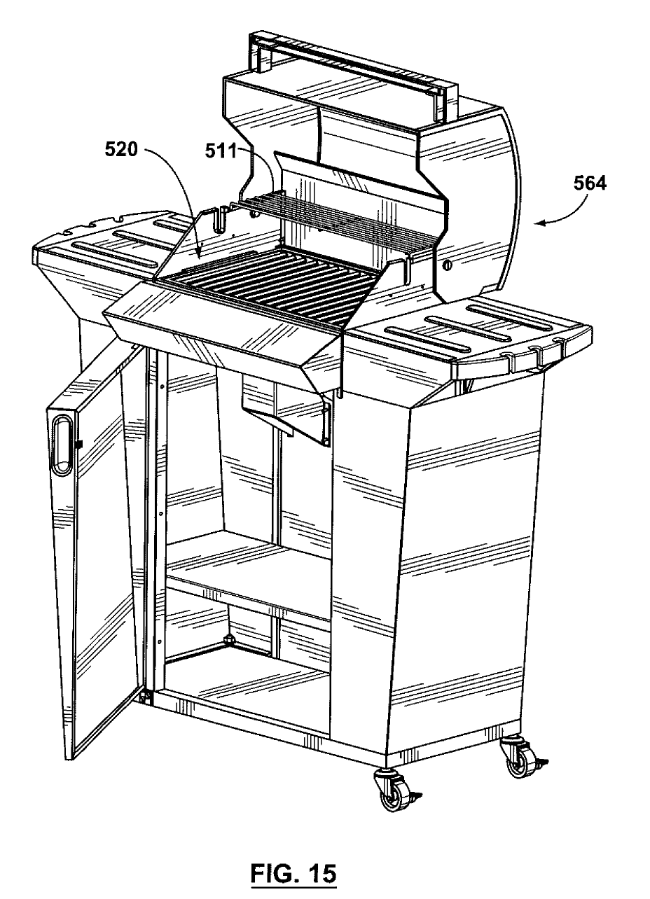

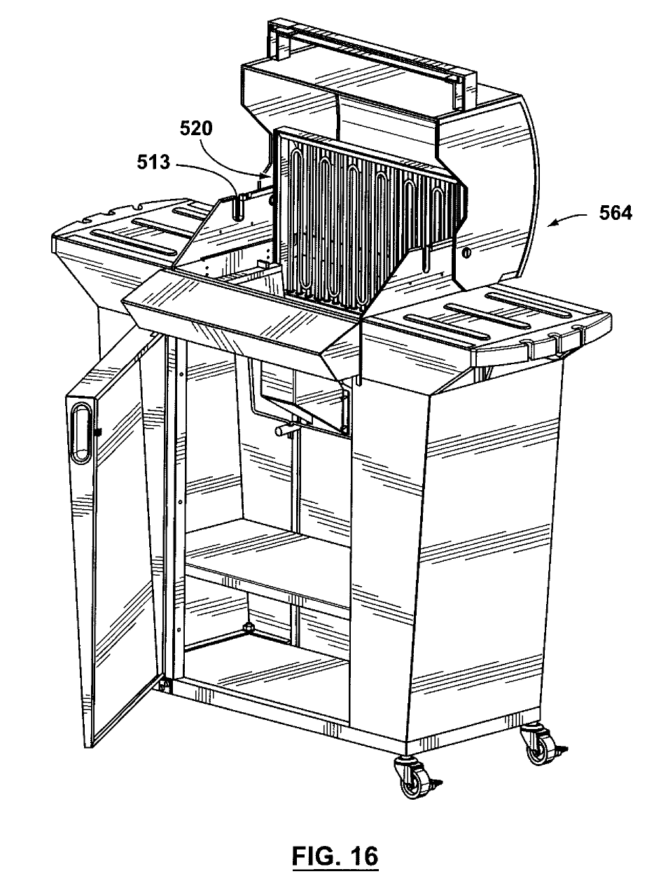

In another alternative embodiment shown in FIGS. 15-24, a barbecue grill 520 for cooking the object 21 preferably includes a first resistive element subassembly 531 and a second resistive element subassembly 533. Preferably, and as can be seen in FIGS. 15 and 16, the barbecue grill 520 is movable between one or more grill positions (FIG. 15), in which the grill is located for grilling the object 21, and one or more broil positions (FIG. 16), in which the grill is located for broiling the object 21. The grill 520 is energizable in the grill positions and in the broil positions, as will be described.

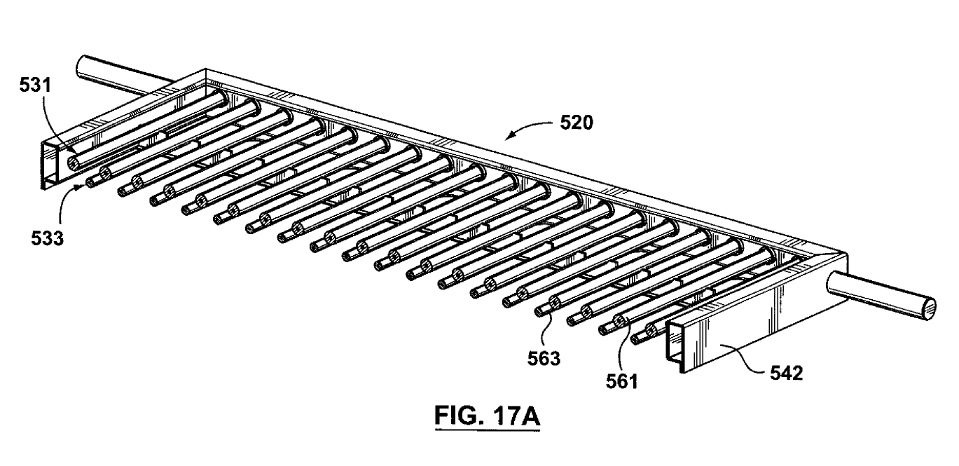

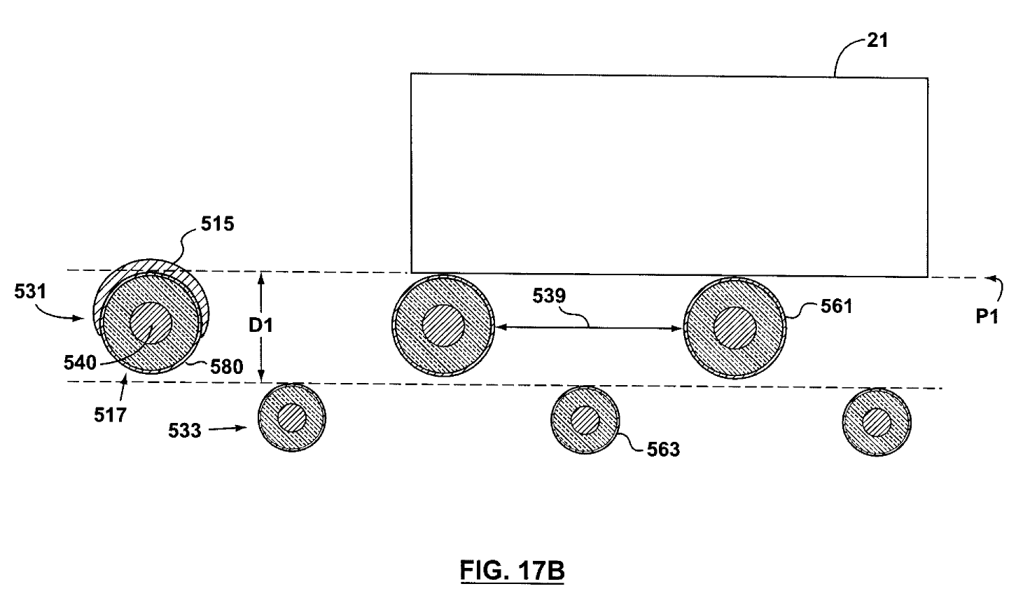

Preferably, the grill 520 includes a frame 542 to which the first and second resistive element subassemblies 531, 533 are attached, so that the frame 542 supports the first and second resistive element subassemblies 531, 533. As can be seen in FIG. 17B, when the grill 520 is in the grill position, the first resistive element subassembly 531 preferably defines a plane “P1” at which the object 21 is substantially supported. It is also preferred that the second resistive element subassembly 533 is spaced apart from the plane by a predetermined distance “D1” selected so that the second resistive element subassembly 533 is sufficiently proximal to the object 21 to at least partially cook the object 21. Preferably, the object 21 is receivable on at least part of the first resistive element subassembly 531 and supportable thereby.

Due to the positioning of the object 21 directly on the first resistive element subassembly 531 when the grill is in the grill position, the object is seared by its contact with the first resistive element subassembly 531, to provide burn markings thereon characteristic of grilled food. Because the grill 520 includes two resistive element subassemblies 531, 533, adequate heat is generated by the resistive element subassemblies in the appropriate proportions, i.e., the first resistive element subassembly 531 produces sufficient heat to make grill markings on the object (and also to partially cook the object) and the second resistive element subassembly 533 produces sufficient heat to partially cook the object, to result in a fully cooked object.

In summary, and as can be seen in FIG. 17B, when the grill 520 is in the grill position, and the object 21 is positioned on the first resistive element subassembly 531, the object is cooked by two sources of heat, namely:
(a) by heat from the first resistive element subassembly 531 transferred to the object by conduction; and
(b) by heat radiated from the second resistive element subassembly 533 to the object 21.

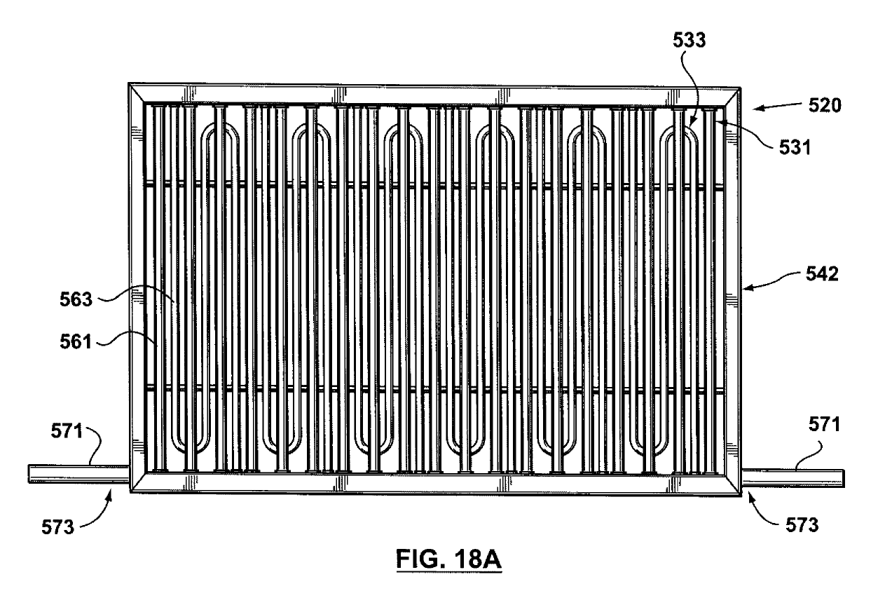

As can be seen in FIG. 18A, it is also preferred that the first resistive element subassembly 531 includes a number of substantially straight first resistive element segments 561 positioned substantially parallel to each other and spaced apart from each other to define gaps 539 therebetween sized to permit liquid released from the object 21 during cooking to pass between the first resistive element segments 561 when the grill 520 is in the grill position.

In addition, the second resistive element subassembly 533 preferably includes a number of substantially straight second resistive element segments 563 which are substantially aligned respectively with the gaps 539, as will be described.

In one embodiment, the grill 520 includes one or more bus bars 565 positioned at least partially in the frame 542, for distributing electrical power to the first and second resistive element subassemblies 531, 533. Preferably, the bus bar 565 is electrically connected to the first and second resistive element subassemblies 531, 533 as represented in FIG. 18B. However, as will be appreciated by those skilled in the art, circuits other than the circuit represented in FIG. 18B may be used to provide electric power to the first and second resistive element subassemblies 531, 533. For example, other circuits could be used to focus the power to the first and second resistive element subassemblies independently (i.e., top and bottom), or laterally (i.e., front and back, or left side and right side), or any combinations thereof, as desired. Accordingly, in an alternative embodiment, the first and second resistive subassemblies 531, 533 are energizable independently of each other.

Preferably, the grill is adapted for self-cleaning. As can be seen in FIG. 17B, a layer 515 of cooked material (e.g., grease, etc.) accumulates on sheaths 580 of individual elements 517. (For clarity of illustration, the layer 515 is shown on only one of the sheaths 580, but it will be understood that in practice all the sheaths accumulate such layers 515 on them over time, to a greater or a lesser extent.) In order to self-clean, the elements 517 are heated to a relatively high temperature (e.g., 650° F. or greater) for a relatively short time period (e.g., about 45 minutes, depending on materials). The ability to energize one portion of the grill independently of other parts thereof also facilitates self-cleaning.

The grill 520 is well-adapted for self-cleaning because the heat for self-cleaning is generated by the resistive element 540 inside the sheath 580, while the cooked material which is to be removed is on the outside of the sheath 580. In contrast, in attempting to self-clean a grill of the prior art, the grill elements therein typically do not have heat-generating elements positioned within them.

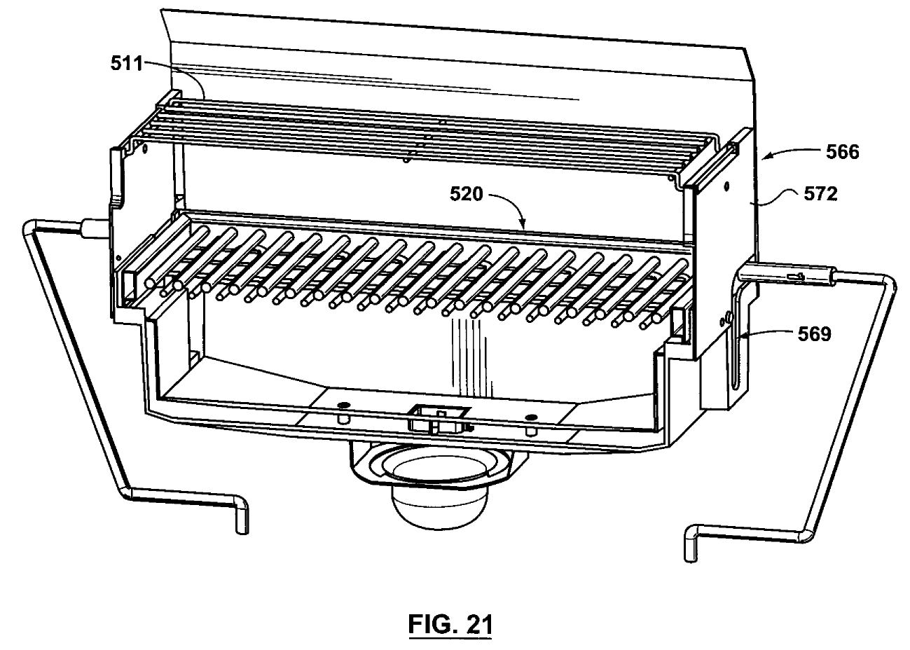

Preferably, the grill 520 is included in a barbecue assembly 564, as shown in FIGS. 15, 16, and 19-23. The barbecue assembly 564 includes a housing (or tub) 566 which preferably has slots 569 in walls 572 of the housing 566 (FIGS. 21, 23) to permit movement of the grill 520 between the grill position(s) and the broil position(s), as will be described.

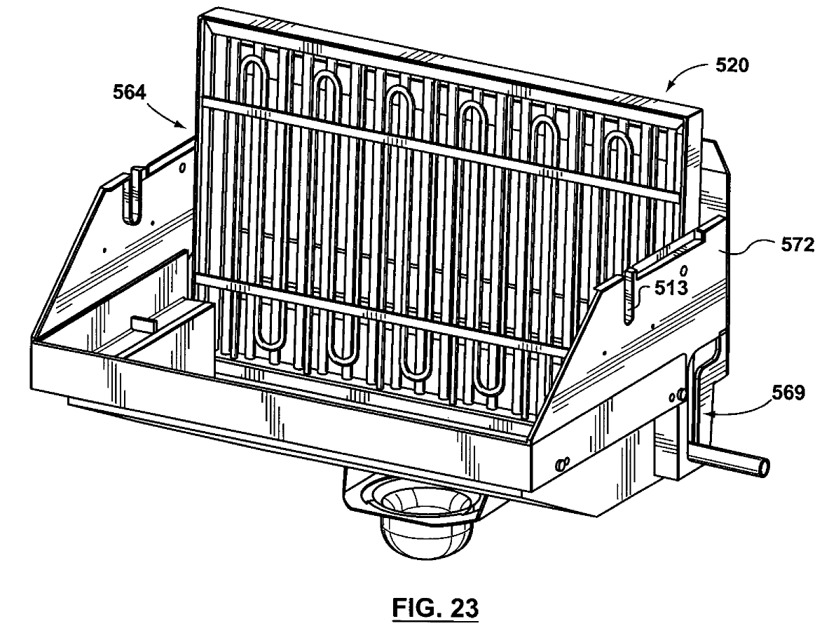

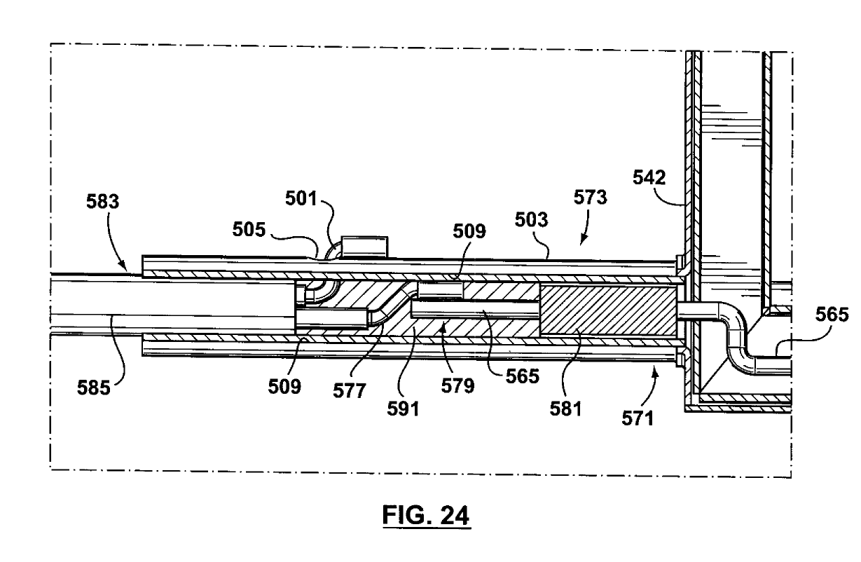

The grill 520 preferably includes connector assemblies 573 (FIG. 24) on two opposing sides thereof (FIG. 18A). Each connector assembly 573 includes, among other things, one of the tubes 571 (FIG. 18A). Preferably, the tubes 571 extend outwardly from two opposing sides of the frame 542 (FIG. 18A). Each connector assembly 573 is for connecting the bus bar 565 to a source of electrical power (not shown) so that the grill 520 is easily movable between the grill position(s) and the broil position(s), as will be described.

Preferably, the bus bar 565 is partially located in the tubes 571 respectively, to connect with supply wires 577 at respective supply connections 579 in the tubes 571 respectively (FIG. 24). Electric power is supplied from the source thereof via the supply wires 577, as is known in the art.

In one embodiment, and as can be seen in FIG. 24, each connector assembly 573 preferably also includes a thermal insulator 581 positioned in the tube 571 between the frame 542 and the supply connection 579. The thermal insulator 581 is for at least partially shielding the respective supply connections 579 from heat generated by the resistive element subassemblies 531, 533. Preferably, the thermal insulator 581 is made of any suitable thermal insulating material. In one embodiment, the thermal insulator 581 is made of a suitable thermoset plastic (e.g., phenol formaldehyde resin, sold under the trademark Bakelite), as is known in the art.

It is also preferred that, in each connector assembly 573, the supply wire 577 extends between the supply connection 579 and a supply wire subassembly 583. Each supply wire subassembly 583 includes a protective covering 585 in which the supply wire 577 and a ground wire 501 are at least partially positioned.

Preferably, and as can be seen in FIG. 24, in each connector assembly 573, the protective covering 585 is held substantially stationary relative to the tube 571 in which the protective covering 585 is located by a fastening material 591 which attaches the protective covering 585 to the tube 571. The attachment of the protective covering 585 to the tube 571 in this way is needed in order that the connector assembly 573 may pass “pull tests” which it is required to satisfy by regulative bodies in certain jurisdictions, as is known in the art.

Preferably, the tube 571 and the frame 542 are made of any suitable metal. For example, stainless steel is a suitable metal for these purposes. As shown in FIG. 24, the tube 571 has an exterior surface 503 to which the ground wire 501 is attached, for grounding. In addition, it is preferred that the tube 571 includes a hole 505. When the connector assembly 573 is assembled, the hole 505 allows the ground wire 501 to be pulled out of the tube 571 to the exterior surface 503 of the tube 571. Subsequently, the ground wire 501 is attached to the exterior surface by any suitable means (e.g., soldering), as is known in the art.

When the connector assembly 573 is assembled, the hole 505 preferably is also used for access, for injection of the fastening material 591 into the tube 571 between the protective covering 585 and the thermal insulator 581. It is preferred that the fastening material 591 is any suitable material for securely attaching the protective covering 585 to an interior surface 509 of the tube 571. Epoxy has been found to be a suitable fastening material 591, as epoxy is injectable to generally fill the tube 571 between the protective covering 585 and the thermal insulator 581, and provides a suitably secure bond between the protective covering 585 and the interior surface 509 of the tube 571 after curing thereof.

As can be seen in FIGS. 15 and 16, the barbecue assembly 564 preferably includes the grill 520. As described above, the grill 520 includes the first and second resistive element subassemblies 531, 533. The barbecue assembly 564 preferably also includes the housing 566 in which the barbecue grill 520 is mounted, for supporting the barbecue grill 520 in one or more predetermined positions, i.e., the grill position(s) and the broil position(s). (As shown, the assembly 564 provides for only one grill position and only one broil position, for clarity of illustration.) The grill 520 is shown in the grill position in FIGS. 15, 21, and 22. The grill 520 is shown in broil positions in FIGS. 16, 19, 20, and 23. As described, the grill 520 is energizable in the grill position and in the broil position.

In use, when the grill 520 is in the grill position (FIG. 15), the tubes 571 are positioned in substantially horizontal portions 591 of the slots 569 on each side of the housing 566 (FIG. 21). (It will be understood that only one side of the housing 566 is shown in FIG. 21 for clarity of illustration. Similarly, when the grill 520 is in the broil position, the tubes 571 are at the bottom of vertical portions 599 of the slots 569 (FIG. 23). It can be seen, therefore, that the grill 520 can easily be moved by a user (not shown) from the grill position to the broil position and vice versa simply by lifting the frame 542 of the grill 520 as necessary in order to cause the tubes 571 to be moved in the slots 569 from the horizontal portion 593 to the vertical portion 599, and vice versa.

As shown in FIGS. 15 and 21, the barbecue assembly 564 includes a conventional rack 511, which is positioned above the grill 520 when the grill 520 is in the grill position. When the user wishes to move the grill 520 from the grill position to the broil position, the user preferably first removes the rack 511.

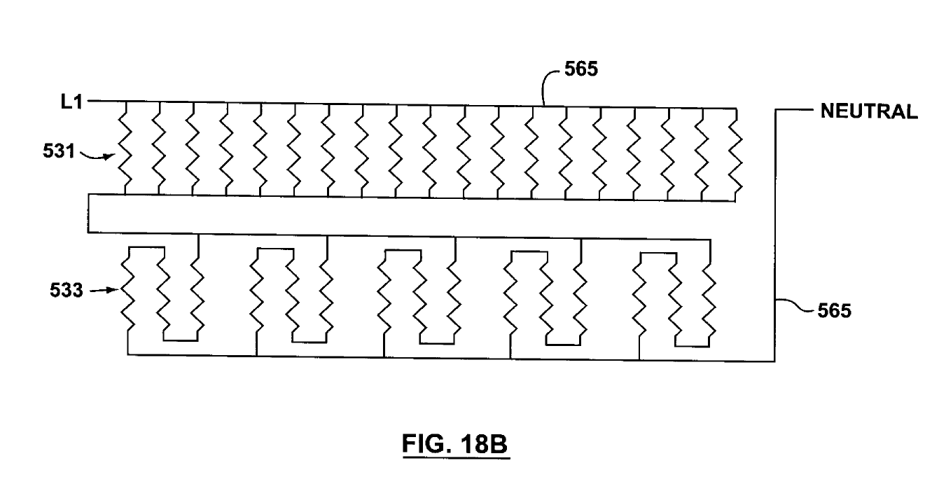

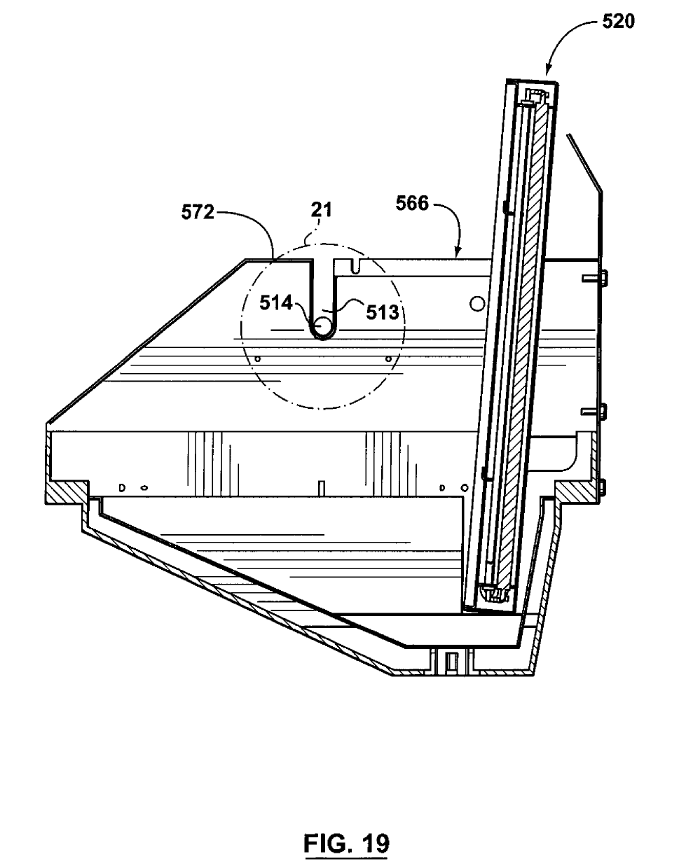

It will be understood that, when the grill 520 is in the broil position, the object to be cooked may be positioned as required relative to the grill 520 in any suitable manner. For example, as can be seen in FIGS. 16 and 23, the walls 572 preferably include slots 513 opening upwardly in which the ends of a spit 514 are receivable, and the object 21 may be positioned on the spit (FIG. 19). As is known, the spit is positionable at the bottom of the slots 513 and rotatable therein so that the object thereon may be cooked relatively uniformly throughout.

In summary, when the grill 520 is in the broil position, the object 21 is cooked by heat which is radiated from both the first and second resistive element subassemblies 531, 533. As can be seen in FIG. 19, when the grill is in the broil position, the object preferably is spaced apart from both of the first and second resistive element subassemblies 531, 533 by an appropriate distance to achieve the desired result in cooking the object.

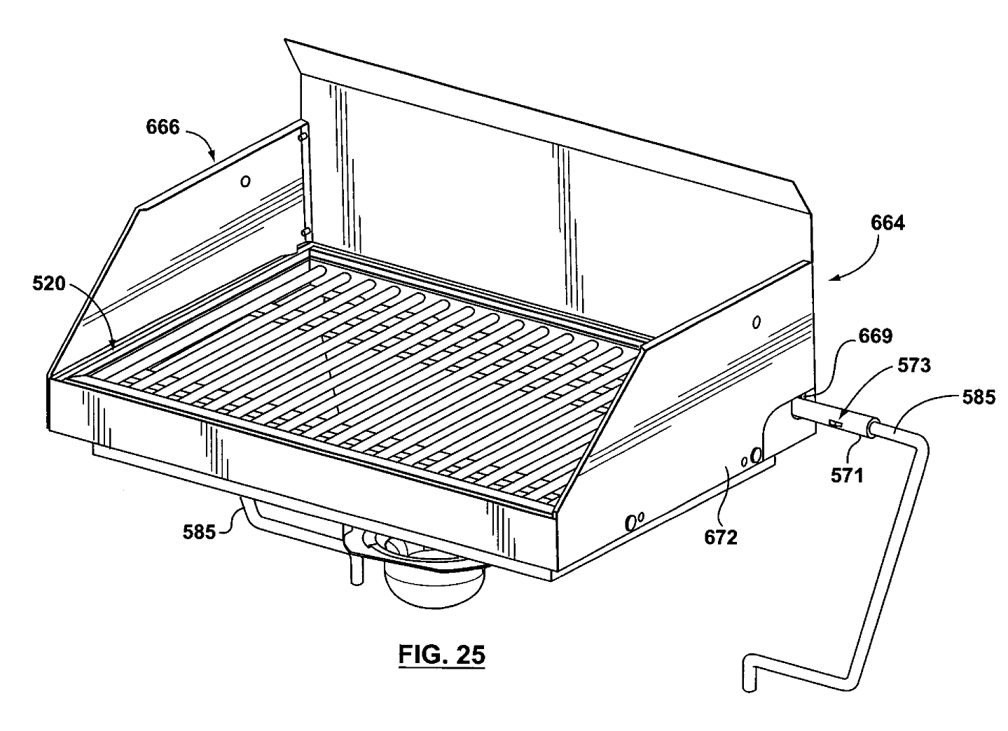

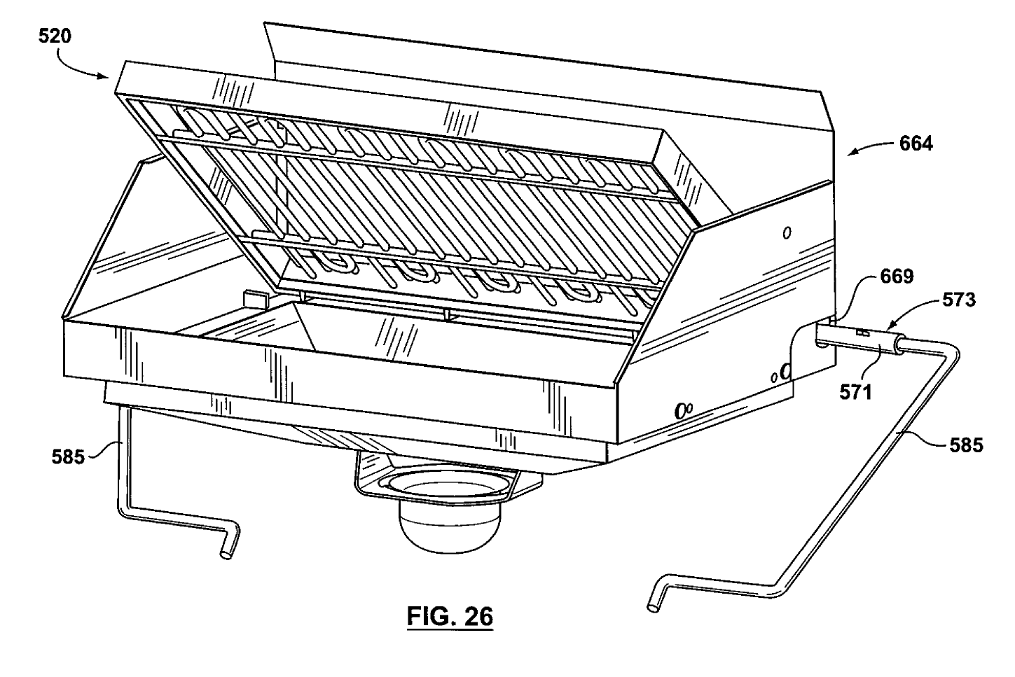

As can be seen in FIGS. 25 and 26, in another embodiment, the barbecue assembly 664 includes a housing 666 with walls 672 including holes 669 in which the tubes 571 are receivable, i.e., rather than the slots. In this assembly 664, the grill 520 is pivotable at its front end from the grill position (FIG. 25) upwardly to a raised position (FIG. 26). Preferably, the grill 520 is held in the raised position by any suitable means, as will be appreciated by those skilled in the art. The grill 520 is located in the raised position to permit cleaning of the housing.

It will be understood that, if the housing is constructed so to permit, then the grill may be positionable in a broil position as well when the tubes are positioned in holes in the housing wall.

It will also be understood that the barbecue assembly could include a barbecue grill 520 which is substantially fixed in place, e.g., in the grill position, if desired. In this embodiment, the connections of the bus bar and the supply wires could be made inside traditional terminal/junction boxes on either or both sides of the grill, as will be appreciated by those skilled in the art.

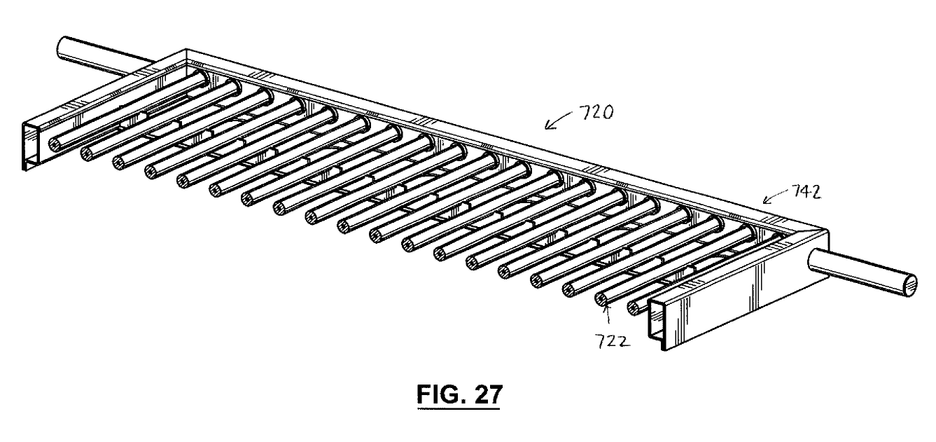

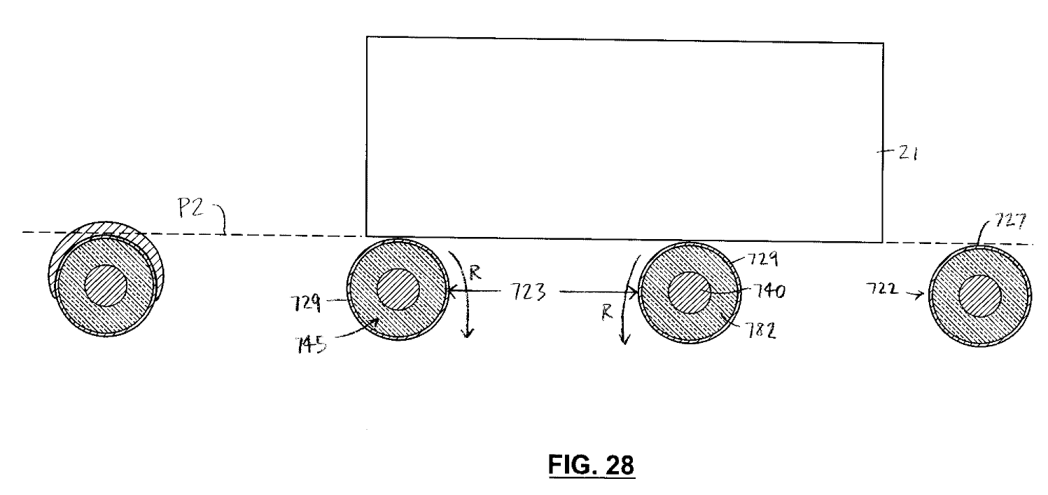

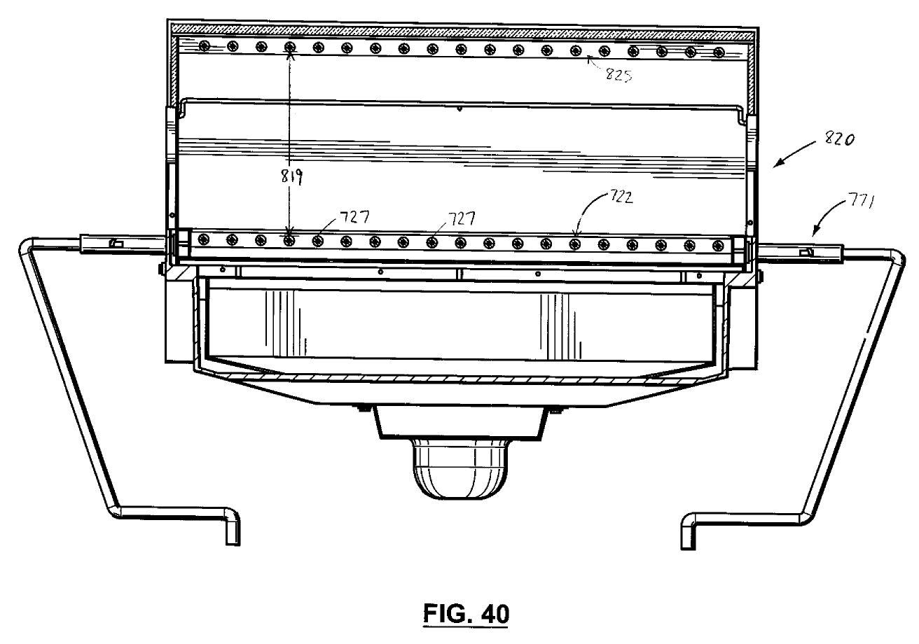

Another embodiment of the barbecue grill 720 of the invention is disclosed in FIGS. 27-32 and in FIG. 40. As can be seen in FIG. 28, the barbecue grill 720 is for cooking the object 21. The barbecue grill 720 includes a number of ribs 722 for supporting the object 21. Each rib 722 preferably includes one or more electrically resistive elements 740 and one or more body portions 729 substantially electrically insulated by an insulator 782 relative to the resistive element 740 (FIG. 28). The resistive element 740 is energizable for generating heat to at least partially cook the object. Also, the insulator 782 preferably is engaged with the body portion 729. It is also preferred that the body portion 729 includes a top surface 727 adapted for engaging the object 21. The ribs 722 preferably are positioned to locate the top surface 727 of each rib 722 substantially in a plane “P2” (FIG. 28). It is also preferred that each rib 722 is spaced apart from one or more ribs proximal thereto by a predetermined distance 723, to allow liquid escaping from the object as it cooks to flow between the ribs 722 under the influence of gravity.

As can be seen in FIGS. 27-29, 31-32, and 40, in one embodiment, the rib 722 consists of a sheathed element, and the body portion 729 is a sheath portion thereof. As will be described, however, various alternate configurations are provided in other embodiments, e.g., the body portions thereof may include a central portion and/or a ridge portion.

Preferably, the ribs 722 are spaced sufficiently far apart (i.e., by the distance 723) from each other that liquid escaping from the object as it is barbecued falls between the ribs 722. As described above, distances between adjacent ribs preferably are minimized, to maximize heat transfer to the object 21. It has been found that a sufficient distance between the ribs 722 is approximately 0.2 inches (5.08 mm.).

It will be understood that the grill 720 is unlikely to be able to generate as much heat as, for example, the grill 520 (FIG. 18A), because the latter grill includes two sets of elements (e.g., one set for engaging the object 21 and transferring heat to the object by conduction, and a second set for transferring heat to the object by radiation). The grill 720 preferably is used where somewhat less heat is required to cook the object.

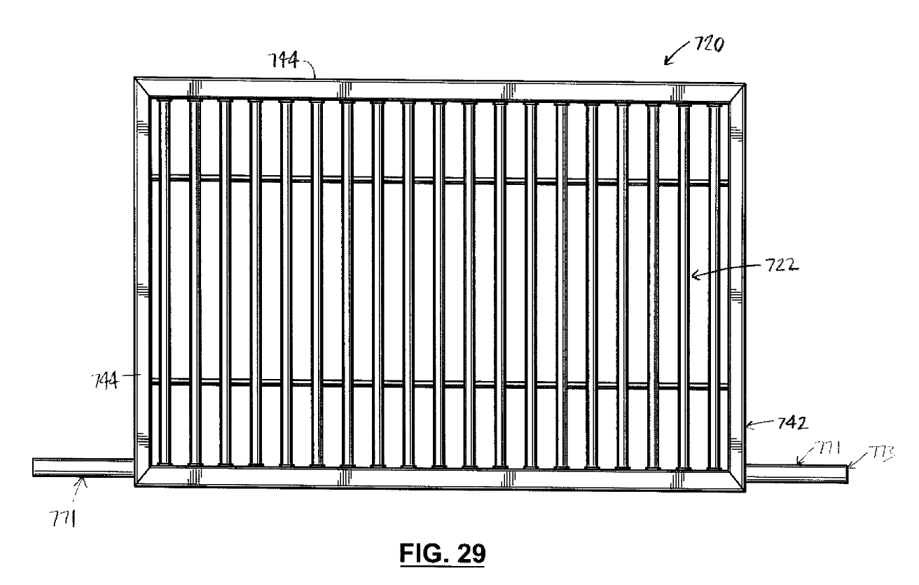

In one embodiment, the barbecue grill 720 preferably includes a frame 742 for supporting the ribs 722 (FIGS. 27, 29). Preferably, the frame 742 includes one or more support members 744 to which the ribs 722 are attached (FIG. 29). The frame 742 preferably also includes one or more tubes 771 extending from selected support members 744, about which tubes 771 the barbecue grill 720 is pivotable between the grill and broil positions.

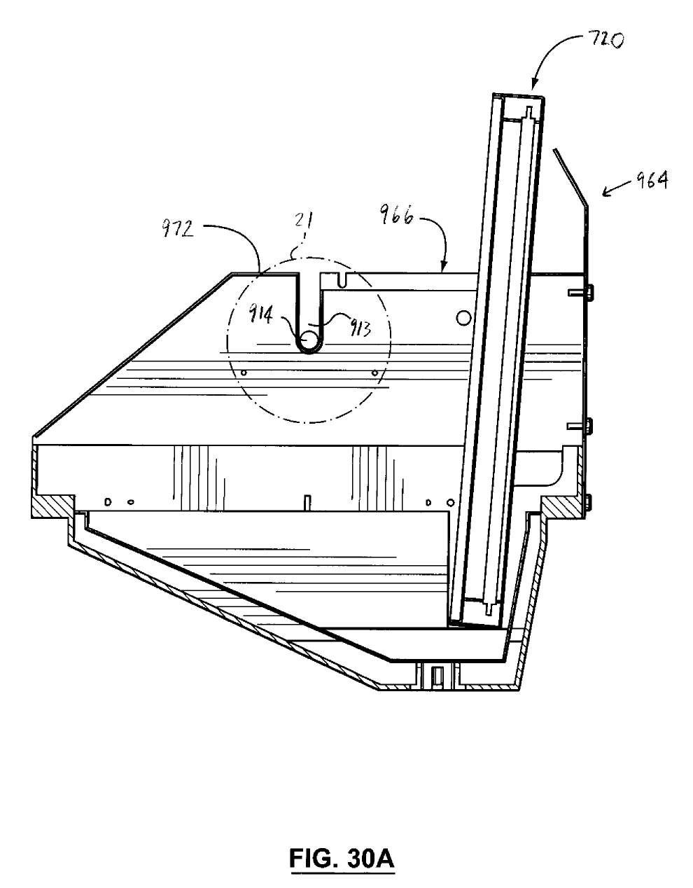

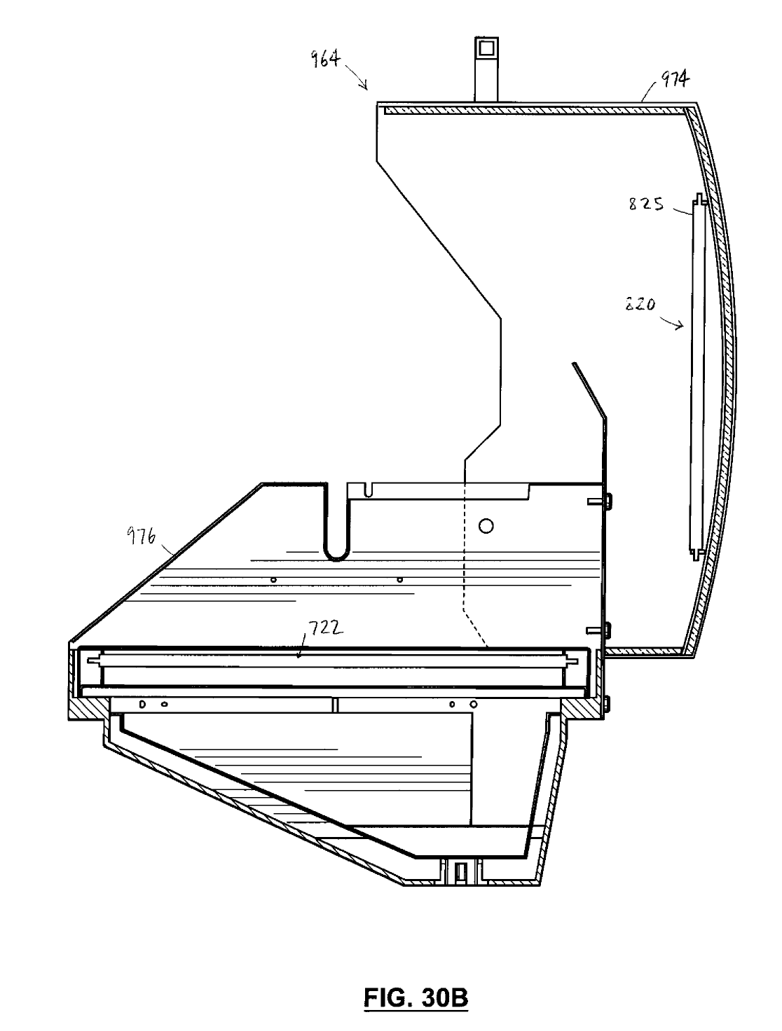

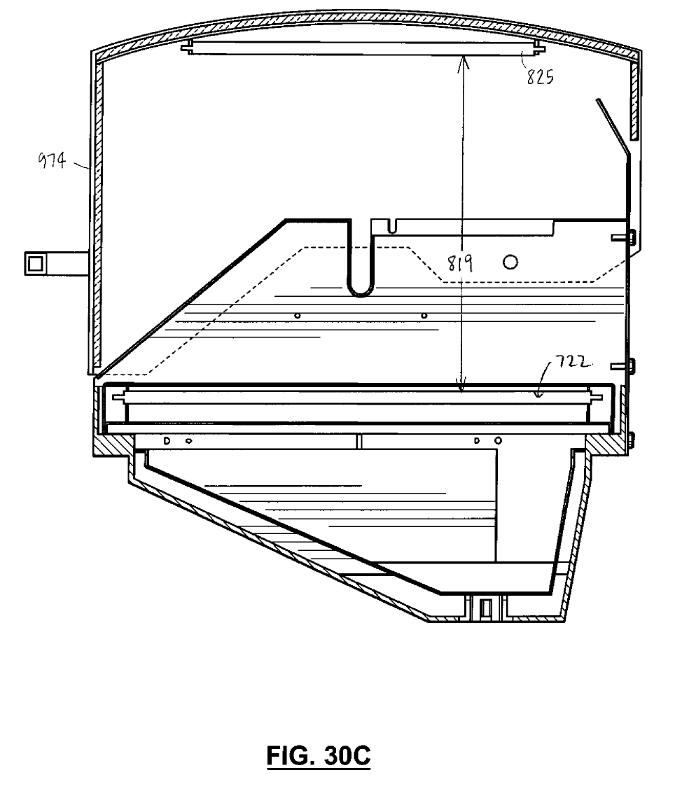

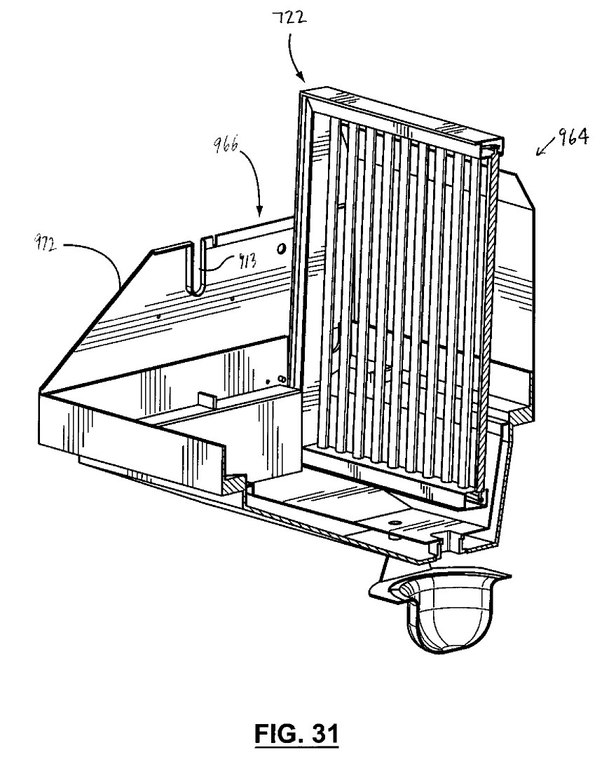

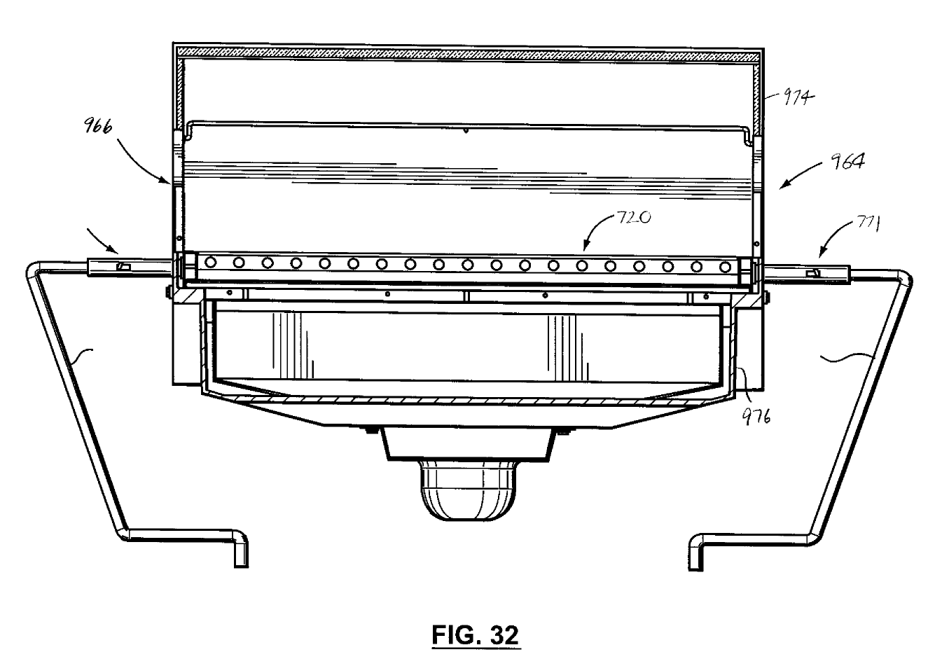

As can be seen in FIGS. 30A, 31 and 32, the ribs 722 are movable between one or more grill positions (FIG. 32), in which the ribs 722 are positioned for grilling the object 21, and one or more broil positions (FIGS. 30A, 31), in which the ribs 722 are positioned for broiling the object 21. The resistive elements 740 are energizable in each of the barbecue grill position and the broil position for generating heat to at least partially cook the object.

It will be understood that, when the ribs 722 are in the grill position (FIG. 32), the barbecue grill 720 including the ribs 722 is also considered to be in the grill position. Similarly, when the ribs 722 are in the broil position, the barbecue grill 720 is also in the broil position. The tubes 771 preferably are included in connector assemblies 773 respectively which, as described above, provide connections to sources of electrical power for the barbecue grill 720 regardless of the position of the barbecue grill (i.e., whether the grill is in the grill position or the broil position).

Preferably, and as shown in FIG. 28, when the ribs 722 are in the grill position, the object 21 is positioned directly on the ribs 722. This results in lines of blackened or charred material (e.g., charred meat, if the object 21 is meat) in the object 21 where the object 21 contacts the top surfaces 727 of the ribs 722, which are generally desirable for showing that the object 21 has been barbecued. When the ribs 722 are in the grill position, the object 21 is supportable at the plane “P2” substantially defined by the top surfaces 727 of the ribs 722 (FIG. 28).

As can be seen in FIG. 28, grease and other liquids released by the object 21 as it is barbecued move downwardly past the ribs 722, under the influence of gravity. The flow of such liquids due to gravity is schematically illustrated by arrows identified as “R” in FIG. 28.

Preferably, and as can be seen in FIG. 28, the resistive element 740 and the insulator 782 are included in an insulated heat-generating subassembly 745 of each rib 722 respectively. The insulated heat-generating subassembly 745 of each rib 722 is engaged with the body portion 729 thereof for heat transfer by conduction from the insulated heat-generating subassembly 745 to the body portion 729. As described above, heat is also transferred by conduction from the body portion 729 to the object 21, i.e., to the parts of the object 21 which are in direct contact with ribs 722 (FIG. 28).

In use, the ribs 722 are located in the grill position and the resistive elements 740 therein are energized. Heat is generated when current is passed through the resistive elements 740. The object(s) 21 is (are) positioned on the ribs 722. Heat is transferred by conduction from the insulated heat-generating subassembly 745 to the body portion 729. As can be seen in FIG. 28, the ribs 722 are positioned to locate the top surfaces 727 substantially in the plane “P2.” Depending on the object 21, liquids may be released from the object 21 as it is cooked. If such liquids are released from the object 21 during cooking, they flow downwardly between the ribs 722 under the influence of gravity.

As can be seen in FIGS. 30B, 30C, and 40, in another embodiment, a barbecue grill 820 of the invention also includes an upper resistive element subassembly 825 energizable for generating heat to at least partially cook the object. The upper resistive element subassembly 825 preferably is positionable a preselected distance 819 apart from the ribs 722, for heat transfer to the object by radiation from the upper resistive element subassembly 825 (FIGS. 30C, 40). Preferably, when objects are being cooked, the upper resistive element subassembly 825 is located approximately 4 inches (101.6 mm.) above the top surfaces 727 of the ribs 722. The upper resistive element subassembly 825 and the ribs 722 preferably are separately energizable, to provide heat as required to cook the object 21.

In one embodiment, the upper resistive element subassembly 825 preferably includes one or more resistive elements 840 and one or more body portions 829 which are substantially electrically insulated relative to the resistive elements 840 respectively. The upper resistive element subassembly 825 includes any suitable arrangement of electrically resistive elements. In one embodiment, for example, the upper resistive element subassembly 825 preferably includes a number of sheathed elements (FIG. 40). Those skilled in the art would appreciate that other suitable arrangements are possible.

Another embodiment of the barbecue assembly 964 of the invention is disclosed in FIGS. 30A, 31, and 32. As can be seen in FIGS. 30A, 31 and 32, the barbecue grill 964 includes the barbecue grill 720 and a tub 966 for supporting the barbecue grill 720. As described above, in one embodiment, the barbecue grill 720 preferably is movable between one or more grill positions (FIG. 32) in which the grill 720 is positioned for grilling the object, and one or more broil positions (FIGS. 30A, 31) in which the grill 720 is positioned for broiling the object 21. The tub 966 includes a top portion 974 which is not shown in FIGS. 30A and 31 to simplify the illustrations.

It will be understood that, when the grill 720 is in the broil position (FIG. 30A), the object to be cooked may be positioned as required relative to the grill 720 in any suitable manner. For example, as can be seen in FIGS. 30A and 31, walls 972 preferably include slots 913 opening upwardly in which the ends of a spit 914 are receivable, and the object 21 may be positioned on the spit (FIG. 30A). As is known, the spit 914 is positionable at the bottom of the slots 913 and rotatable therein so that the object thereon may be cooked relatively uniformly throughout.

In one embodiment, the barbecue assembly 964 preferably also includes the upper resistive element subassembly 825 energizable for generating heat to at least partially cook the object, the upper resistive element subassembly being positionable the preselected distance 819 apart from the ribs 722 (FIGS. 30B, 30C, and 40). As can be seen in FIGS. 30C and 40, the upper resistive element subassembly 825 is positionable at the distance 819 above the ribs when the ribs 722 are in the grill position. Preferably, the upper resistive element subassembly 825 includes one or more electrically resistive elements 840, and one or more body portions 829 which are substantially electrically insulated by the insulator 882 relative to the resistive element 840.

In one embodiment, the tub 966 of the barbecue assembly 964 includes a bottom portion 976 and the top portion 974 movable relative to the bottom portion 976 between a closed position (FIGS. 30C, 40), in which the upper resistive element subassembly 825 is positioned above the ribs 722, and an open position (FIG. 30B), in which the ribs 722 are accessible. Preferably, and as shown in FIGS. 30B, 30C, and 40, the upper resistive element subassembly 825 is mounted in the top portion 974.

It will be understood that the ribs of the invention may be manufactured in many different ways, using a variety of materials.

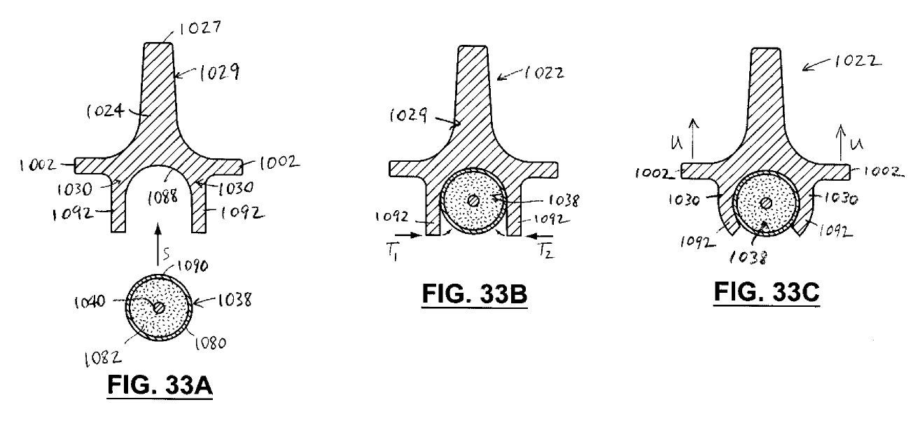

For instance, in one embodiment, a method of forming an embodiment of the rib 1022 of the invention includes, first, providing a body portion 1029 with a contact surface 1088 thereon (FIG. 33A). Next, a resistive element subassembly 1038 which is at least partially adapted for engagement with the contact surface 1088 for transferring heat to the body portion 1029 by conduction is provided, as shown in FIG. 33A. The resistive element subassembly 1038 preferably includes a sheath 1080, an insulator 1082, and one or more electrically resistive elements 1040 substantially electrically insulated from the sheath 1080 by the insulator 1082. The resistive element 1040 is energizable for generating heat. The body portion 1029 includes a central part 1024 and one or more ridge parts 1030 extending therefrom, each ridge part 1030 also including a body segment 1092. In the next step of the method of the invention, the sheath 1080 of the resistive element subassembly 1038 is engaged with the contact surface 1088 (FIG. 33B). In the final step of the method, at least one of the body segments 1092 is engaged with the resistive element subassembly 1038, to urge the sheath 1080 against the contact surface 1088 (FIGS. 33B, 33C). Preferably, in use, the object 21 is positioned on a top surface 1027. Heat is conducted to the object 21 via the central part 1024 to the top surface 1027 and thus to the object.

As can be seen in FIG. 33A, to assemble the rib 1022, the resistive element subassembly 1038 preferably is moved in the direction indicated by arrow “S” until the body portion 1029 of the resistive element subassembly 1038 engages the contact surface 1088. Once the resistive element subassembly 1038 is engaged with the contact surface 1088, the body segments are pressed inwardly as indicated by arrows “T₁” and “T₂” in FIG. 33B until the resistive element subassembly 1038 is tightly engaged thereby.

Preferably, and as can be seen in FIGS. 33A-33C, the body portion 1029 also includes at least one arm 1002 projecting transversely therefrom. The arm 1002 is adapted for radiating heat transferred thereto from the resistive element subassembly 1038 (i.e., via the main part 1024) upwardly from an upper surface 1004 thereof (as indicated by arrow “U” in FIG. 33C) to cook the object 21.

Preferably, the resistive element subassembly 1038 includes one or more mating surfaces 1090 shaped for mating with the contact surface 1088 for substantially engaging the mating surface 1090 with the contact surface 1088, for heat transfer by conduction from the resistive element subassembly 1038 to the body portion 1029.

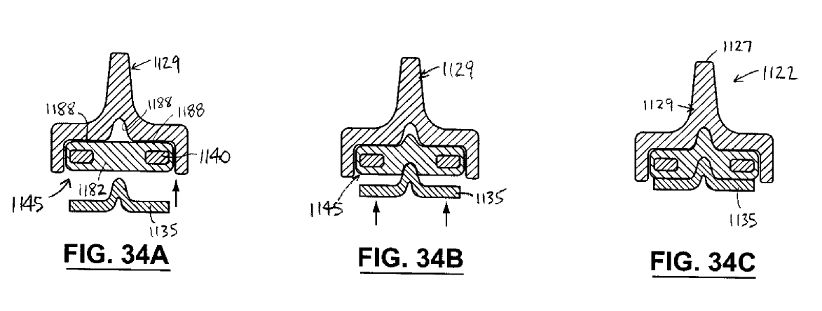

Another method of forming a rib 1122 of the invention is disclosed in FIGS. 34A-34C. This embodiment of the method of the invention includes, first, providing a first body portion 1129 including one or more contact surfaces 1188. In the next step of the method of the invention, an insulated heat-generating subassembly 1145 is provided. The insulated heat-generating subassembly 1145 includes one or more resistive elements 1140 positioned in an insulator 1182 substantially electrically insulating the resistive elements 1140 relative to the first body portion 1129 (FIG. 34A). The insulator 1182 is adapted for engagement with the contact surface 1188 for heat transfer from the insulated heat-generating subassembly 1145 to the first body portion 1129 by conduction. Finally, the insulated heat-generating subassembly 1145 is engaged with a second body portion 1135 to urge the insulated heat-generating subassembly 1145 against the contact surface 1188.

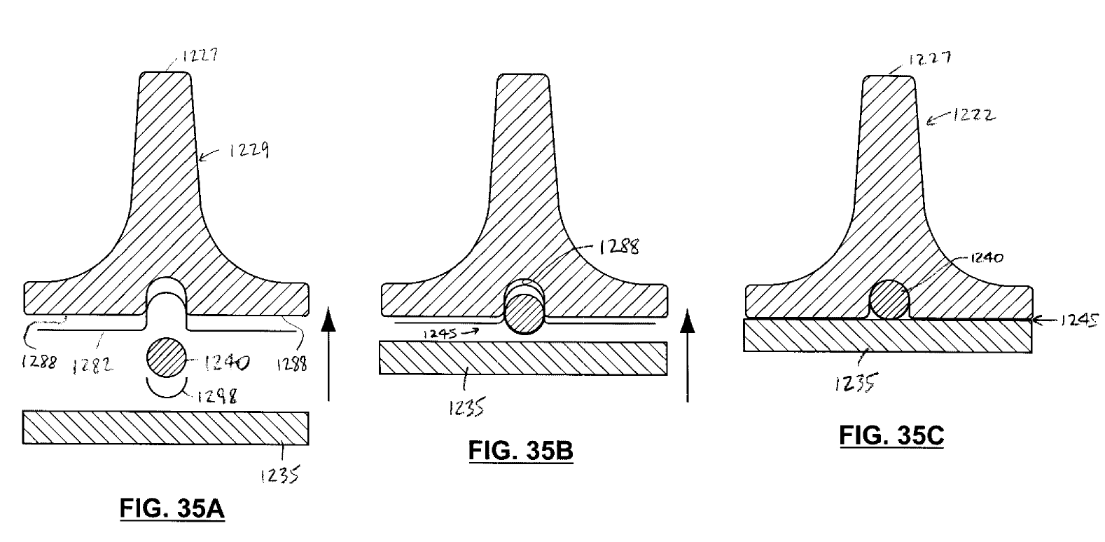

Another method of forming a rib 1222 of the invention is disclosed in FIGS. 35A-35C. This embodiment of the method of the invention includes, first, providing a first body portion 1229 with a top surface 1227 adapted for engaging the object 21 (not shown in FIGS. 35A-35C) and one or more contact surfaces 1288. Next, a first insulator layer 1282 is positioned on (or proximal to) the contact surface 1288 (FIGS. 35A, 35B). In the next step, a second insulator layer 1298 is provided. One or more resistive elements 1240 is positioned between the first and second insulator layers 1282, 1298. The resistive element 1240 is energizable for generating heat. The first and second insulator layers 1282, 1298 and the resistive element 1240 comprise an insulated heat-generating subassembly 1245. Next, the insulated heat-generating subassembly 1245 is engaged with a second body portion 1235 to urge the insulated heat-generating subassembly 1245 against the contact surface 1288 for heat transferred by conduction from the insulated heat-generating subassembly 1245 to the first body portion 1229. The insulator layers 1282 and 1298 substantially electrically insulate the resistive element 1240 relative to the first and second body portions 1229, 1235 respectively.

The first and second insulator layers 1282, 1298 preferably are any suitable dielectric material, provided in any suitable form. The layers 1282, 1298 are schematically illustrated in FIGS. 35A-35C. For example, one or both of the layers 1282, 1298 preferably are a suitable ceramic which is sprayed onto the first body portion 1229 and the resistive element 1240 respectively. Alternatively, one or both of the layers 1282, 1298 preferably are relatively thin layers of any suitable dielectric, e.g., mica.

The second body portion 1235 preferably is maintained in position (as shown in FIG. 35C) by any suitable means. For instance, in one embodiment, the second body portion 1235 preferably is welded to keep it in position once the rib 1222 is assembled. For example, the ends of the second body portion 1235 may be spot welded to the first body portion 1229. Other suitable means of holding the second body portion 1235 in position will occur to those skilled in the art.

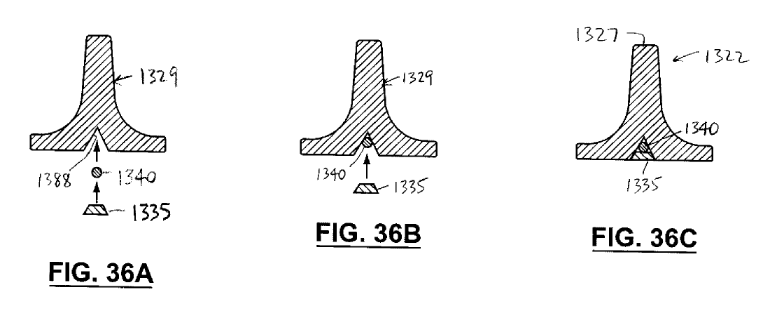

FIGS. 36A-36C disclose yet another method of forming a rib 1322 of the invention. This embodiment of the method of the invention includes, first, providing a first body portion 1329 including a dielectric material. The body portion 1329 includes a top surface 1327 adapted for engaging the object 21 and one or more contact surfaces 1388. Next, one or more resistive elements 1340 is engaged with the contact surface 1388. The resistive element 1340 is energizable for generating heat. Finally, a second body portion 1335 including a dielectric material is engaged with the resistive element 1340, to urge the resistive element 1340 against the contact surface 1388 for heat transfer by conduction from the resistive element 1340 to the first body portion 1329. For example, a suitable ceramic (i.e., having suitable heat conduction characteristics) is a suitable dielectric material.

It will be understood that the second body portion 1335 is schematically represented in FIGS. 36A-36C. The second body portion 1335 preferably is a suitable dielectric material which is maintained in position (as shown in FIG. 36C) by any suitable means. For instance, in one embodiment, the second body portion 1335 preferably is a suitable dielectric material (e.g., a suitable ceramic) which is provided in a liquid form and poured over or sprayed onto the resistive element and the contact surface (when the resistive element is engaged with the contact surface 1388), so that the material bonds to the contact surface and the resistive element upon cooling (and/or curing) thereof. For example, a suitable dielectric material for the second body portion 1335 is a suitable ceramic.

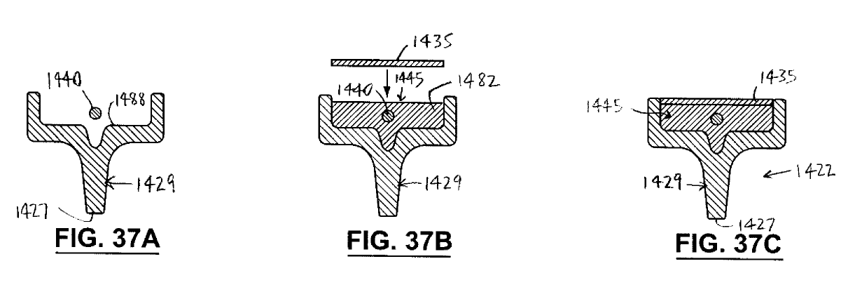

Another method of forming a rib 1422 is disclosed in FIGS. 37A-37C. For convenience, the rib 1422 is shown upside down in FIGS. 37A-37C. However, it will be understood that, in normal use, the rib 1422 is positioned so that a top surface 1427 thereof is positioned upwardly, i.e., for engagement with the object 21. This embodiment of the method of the invention includes, first, providing a first body portion 1429 with the top surface 1427 adapted for engaging the object. The first body portion 1429 preferably also includes one or more contact surfaces 1488. Next, one or more resistive elements 1440 is positioned in a preselected position relative to the contact surface 1488. The resistive element 1440 is energizable for generating heat. Next, an insulator 1482 is positioned around the resistive element 1440. The insulator 1482 substantially electrically insulates the resistive element 1440 relative to the first body portion 1429. The insulator 1482 preferably is adapted for bonding with the contact surface 1488. The resistive element 1440 and the insulator 1482 comprise an insulated heat-generating subassembly 1445. Finally, a second body portion 1435 is engaged with the insulated heat-generating subassembly 1445 to hold the insulated heat-generating subassembly 1445 against the contact surface 1488 for heat transfer by conduction from the insulated heat-generating subassembly 1445 to the first body portion 1429.

Preferably, the insulator 1482 is any suitable dielectric material. In order to position the insulator 1482 around the resistive element 1440, the first body portion 1429 preferably is temporarily inverted, as shown in FIGS. 37A-37C. (It will be understood that, when the ribs 1422 are in use, they are positioned with the top surface 1427 oriented upwardly, for engagement with the object 21 which is to be supported by the ribs 1422.) For instance, a suitable dielectric material 1482 is magnesium oxide, which is positioned between the resistive element 1440 and the first body portion 1429, and also positioned to be located between the resistive element 1440 and the second body portion 1435.

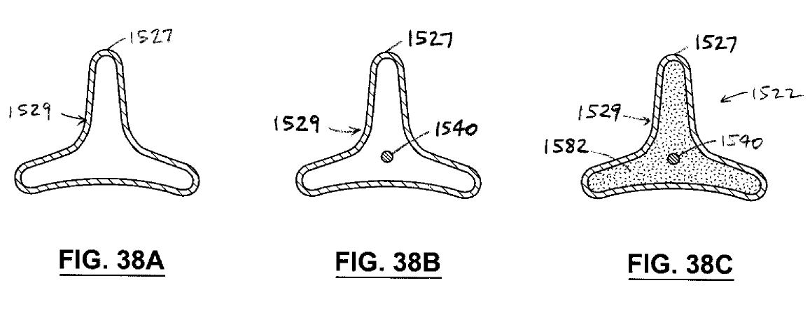

Another method of forming a rib 1522 of the invention is disclosed in FIGS. 38A-38C. This embodiment of the method of the invention includes, first, forming a sheath portion 1529 into a predetermined shape in which the sheath portion 1529 includes a top surface 1527 adapted for engaging the object. Next, one or more resistive elements 1540 is positioned in the sheath portion 1529. The resistive element 1540 is energizable for generating heat. Finally, an insulator 1582 is positioned inside the sheath portion 1529 for substantially electrically insulating the resistive element 1540 relative to the sheath portion 1529. The insulator 1582 engages the sheath portion 1529 for heat transfer by conduction from the resistive element 1540 to the sheath portion 1529 via the insulator 1582.

It will be understood that the sheath portion 1529 may be formed into a variety of shapes. The shape of the sheath portion 1529 shown in FIGS. 38A-38C is advantageous because it includes the top surface 1527.

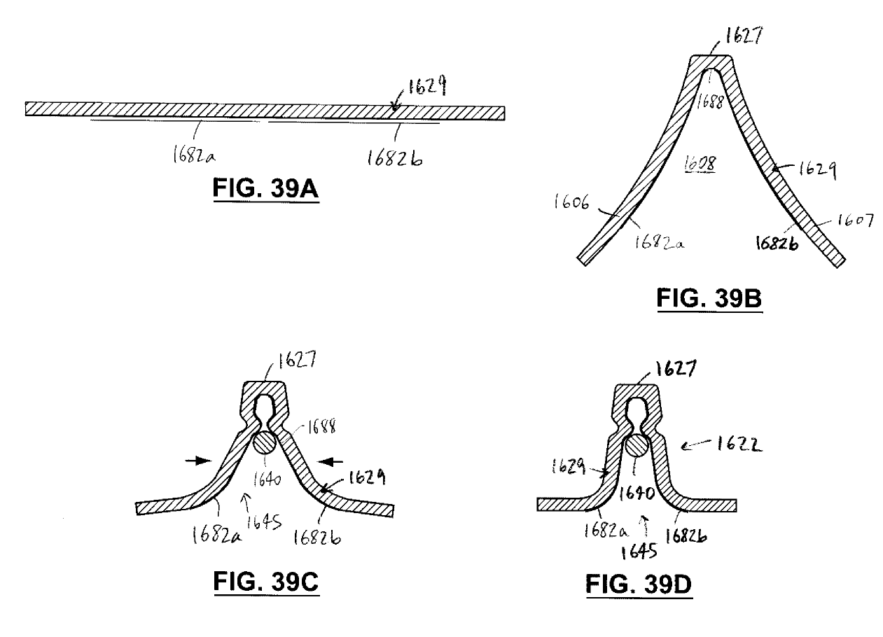

Yet another method of forming a rib 1622 of the invention is disclosed in FIGS. 39A-39D. This embodiment of the method of the invention includes, first, providing a body portion 1629 with a top surface 1627 adapted for engaging the object 21 and side parts 1606, 1607 extending from the top surface 1627 to substantially define a groove 1608. The body portion 1629 also includes one or more contact surfaces 1688 located at least partially in the groove 1608. Next, one or more insulators 1682 including an electrically-insulating material are located in the groove 1608, or proximal thereto. As can be seen in FIG. 39B, two insulators 1682a, 1682b preferably are positioned on the side parts 1606, 1607 respectively. One or more resistive elements 1640 is positioned in the groove 1608 so that the resistive element 1640 is substantially electrically insulated relative to the body portion 1629 by the insulators 1682a, 1682b. The resistive element 1640 is energizable for generating heat. The resistive element 1640 and the insulators 1682a, 1682b comprise an insulated heat-generating subassembly 1645. Finally, one or more of the side parts 1606, 1607 is moved relative to the other, to squeeze the insulated heat-generating subassembly 1645 and to urge the contact surface 1688 against the insulated heat-generating subassembly 1645, for transferring heat by conduction from the insulated heat-generating subassembly 1645 to the body portion 1629.

The insulator 1682 preferably is any suitable dielectric. The layers 1682a, 1682b are schematically illustrated in FIGS. 39A-39D. For example, the layers of insulators 1682a, 1682b preferably are a suitable ceramic sprayed onto the contact surface 1688. Alternatively, and also as another example, the layers 1682a, 1682b preferably are relatively thin layers of mica.

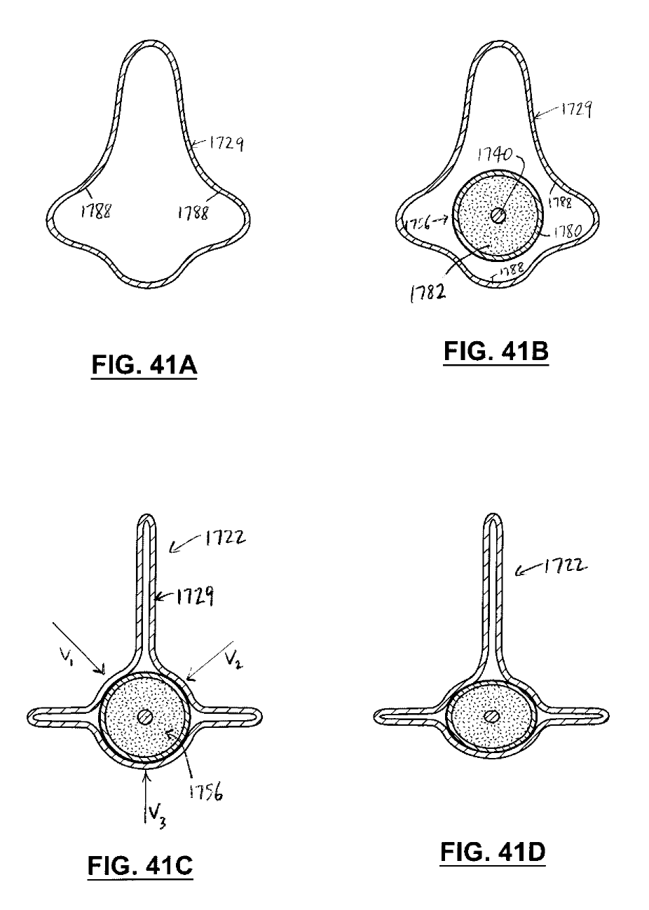

Another method of forming a rib 1722 of the invention is disclosed in FIGS. 41A-41C. This embodiment of the method of the invention includes providing a hollow body portion 1729 with one or more contact surfaces 1788 inside the body portion 1729 (FIG. 41A). Next, a sheathed element 1756 is positioned in the body portion 1729 (FIG. 41B). The sheathed element 1756 includes a sheath 1780 in which one or more resistive elements 1740 is positioned. The resistive element 1740 is substantially electrically insulated by an insulator 1782 relative to the sheath 1780. The resistive element 1740 is energizable for generating heat. The insulator 1782 engages the sheath 1780 for heat transfer by conduction from the resistive element 1740 to the sheath 1780, via the insulator 1782. Preferably, a top surface 1727 adapted to engage the object is formed on the body portion. The body portion 1729 preferably is pressed inwardly in preselected locations (as indicated by arrows V₁, V₂, and V₃ in FIG. 41C) so that the body portion 1729 is formed to urge the contact surface 1788 against the sheathed element 1756, for heat transfer by conduction from the sheathed element 1780 to the body portion 1729.

The body portion 1729 preferably is made of any suitable material(s), and formed in any suitable manner. The body portion 1729 preferably has suitable heat conduction characteristics. For instance, the body portion 1729 preferably is, initially, a steel tube having a wall of suitable thickness. The tube preferably is formed into a generally appropriate shape (FIGS. 41A, 41B) in accordance with known methods before the sheathed element 1756 is positioned inside the body portion 1729. After the sheathed element 1756 is positioned inside the body portion 1729, the body portion 1729 is pressed inwardly to form the top surface 1727 and to engage the contact surface with the sheathed element 1756.

However, alternatives will occur to those skilled in the art. For example, the body portion may be provided in two or more discrete parts (i.e., rather than tubing), which are welded together to form the body portion 1729.

FIG. 41D discloses another embodiment of the rib 1722. In FIG. 41D, the sheathed element 1756 has a substantially oval shape in cross-section, in comparison to the substantially round cross-section of the sheathed element 1756 in FIG. 41C.

It will be understood that the order in which the steps of the various embodiments of the method of forming the barbecue grill (or a rib thereof) of the invention are performed may be altered somewhat.

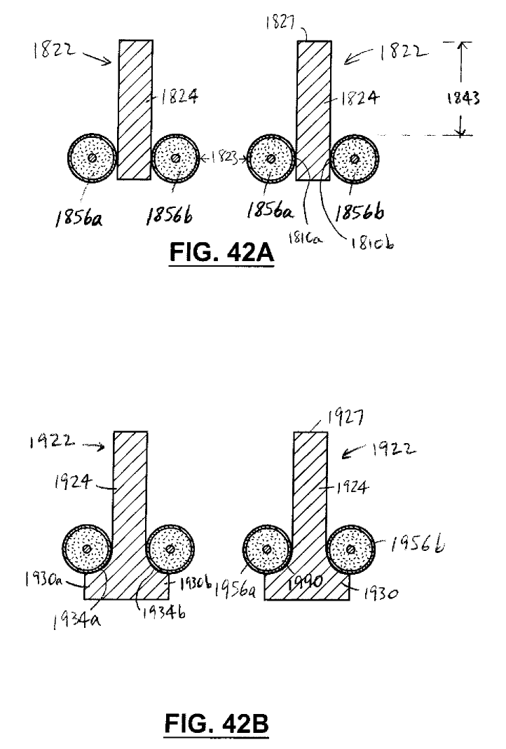

Another embodiment of a barbecue grill 1820 of the invention is disclosed in FIG. 42A. The barbecue grill 1820 preferably includes a number of elongate ribs 1822 with central portions 1824 thereof for engaging the object. The ribs 1822 are spaced apart from each other by at least a first pre-selected distance 1823 to permit liquid from the object 21 to pass between the ribs 1822 under the influence of gravity. The barbecue grill 1820 preferably includes one or more sheathed elements 1856. Each sheathed element 1856 includes a sheath 1880, one or more resistive elements 1840 at least partially positioned in the sheath 1880, and an insulator 1882 substantially electrically insulating the resistive element 1840 relative to the sheath 1880. The resistive element 1840 is energizable for generating heat. In one embodiment, the sheathed element 1856 preferably is positioned a second preselected distance 1843 below the object. Also, the sheathed element 1880 is connected to the central portion 1824 for transferring heat by conduction to the central portion 1824.

In one embodiment, and as can be seen in FIG. 42A, the rib 1822 preferably includes two sheathed elements 1856a, 1856b, attached to sides of the central portion 1824. For instance, the sheathed elements 1880a, 1880b preferably are welded to sides 1810a, 1810b of the central portion 1824. It will be appreciated by those skilled in the art that various means for attaching the sheathed elements 1880a, 1880b would be suitable. The sheathed elements 1880a, 1880b preferably are substantially securely attached to the central portion 1824 to permit heat transfer by conduction from the sheathed elements 1880a, 1880b to the central portion 1824.

An alternative embodiment of ribs 1922 of the invention is disclosed in FIG. 42B. In this embodiment, each rib 1922 includes a central portion 1924 to which ridge portions 1930 are attached. Preferably, and as can be seen in FIG. 42B, the central portion 1924 and the ridge portions 1930a, 1930b are integrally formed, for heat transfer by conduction from the ridge portions 1930a, 1930b to the central portion 1924. The central portion 1924 includes a top surface 1927 adapted to engage the object 21.

The ridge portion 1930a, 1930b preferably include upper surfaces 1934a, 1934b respectively which are shaped to receive the sheathed elements 1956a, 1956b so as to substantially completely engage engagement portions 1990 of the sheaths 1980a, 1980b, of the sheathed elements 1956a, 1956b, for heat transfer by conduction from the sheathed elements 1956a, 1956b to the ridge portions 1930a, 1930b and to the central portion 1924. The sheathed elements 1956a, 1956b preferably are secured to the upper surfaces 1934a, 1934b of the ridge portions 1930a, 1930b by any suitable means. For example, the sheathed elements 1956a, 1956b preferably are spot welded to hold them in position as shown in FIG. 42B.

Any element in a claim that does not explicitly state “means for” performing a specific function, or “step for” performing a specific function, is not to be interpreted as a “means” or “step” clause as specified in 35 U.S.C. §112, paragraph 6.

It will be appreciated by those skilled in the art that the invention can take many forms, and that such forms are within the scope of the invention as claimed. Therefore, the spirit and scope of the appended claims should not be limited to the descriptions of the preferred versions contained herein.

We claim:

1. A barbecue grill for cooking an object, the barbecue grill comprising:
a plurality of ribs for supporting the object, each said rib comprising at least one resistive element and at least one body portion of said rib substantially electrically insulated by an insulator relative to said at least one resistive element, said at least one resistive element being energizable for generating heat to at least partially cook the object, the insulator being engaged with said at least one body portion for heat transfer by conduction to said at least one body portion; and
said at least one body portion comprising a top surface adapted for engaging the object, the ribs being positioned to locate the top surface of each said rib substantially in a plane, each said rib being spaced apart from at least one of said ribs proximal thereto by a predetermined distance to allow liquid escaping from the object to flow between said ribs under the influence of gravity.

2. A barbecue grill according to claim 1 comprising a frame for supporting the ribs.

3. A barbecue grill according to claim 1 in which the ribs are movable between at least one grill position, in which the ribs are positioned for grilling the object, and at least one broil position, in which the ribs are positioned for broiling the object, said at least one resistive element being energizable in each of said at least one barbecue grill position and said at least one broil position for generating heat to at least partially cook the object.

4. A barbecue grill according to claim 3 in which, when the ribs are in said at least one grill position, the object is supportable at the plane substantially defined by the top surfaces of the ribs.

5. A barbecue grill according to claim 1 in which said at least one resistive element and each said insulator of each said rib collectively comprise an insulated heat-generating subassembly of each said rib respectively, the insulated heat-generating subassembly being engaged with said at least one body portion thereof for heat transfer by conduction from the insulated heat-generating subassembly to said at least one body portion.

6. A barbecue grill according to claim 1 additionally comprising an upper resistive element subassembly energizable for generating heat to cook the object and positionable a preselected distance apart from said ribs, for heat transfer by radiation.

7. A barbecue grill according to claim 3 additionally comprising an upper resistive element subassembly energizable for generating heat to at least partially cook the object located a preselected distance above said ribs, for heat transfer by radiation when said ribs are in said at least one grill position.

8. A barbecue grill according to claim 7 in which the upper resistive element subassembly comprises at least one resistive element and at least one body portion substantially electrically insulated relative to said at least one resistive element.

9. A barbecue assembly for cooking an object, the barbecue assembly comprising:
a barbecue grill as claimed in claim 1; and
a tub for supporting the barbecue grill.

10. A barbecue assembly according to claim 9 in which the barbecue grill is movable between at least one grill position, in which the barbecue grill is positioned for grilling the object, and at least one broil position, in which the barbecue grill is positioned for broiling the object.

11. A barbecue assembly according to claim 10 additionally comprising an upper resistive element subassembly energizable for generating heat to at least partially cook the object and positionable a preselected distance apart from the barbecue grill.

12. A barbecue assembly according to claim 11 in which the upper resistive element subassembly is positionable above the barbecue grill when the barbecue grill is in said at least one grill position.

13. A barbecue assembly according to claim 11 in which the upper resistive element subassembly comprises at least one resistive element and at least one body portion substantially electrically insulated by an insulator relative to said at least one resistive element.

14. A barbecue assembly according to claim 11 in which the tub comprises:
a bottom portion for supporting the barbecue grill; and
a top portion movable relative to the bottom portion between a closed position, in which the upper resistive element subassembly is positioned above the barbecue grill, and an open position, in which the barbecue grill is accessible.

15. A barbecue assembly according to claim 14 in which the upper resistive element subassembly is mounted in the top portion.

16. A method of forming a rib in a barbecue grill for cooking an object, the method comprising:
(a) providing a body portion comprising at least one contact surface;
(b) providing at least one resistive element subassembly at least partially adapted for engagement with said at least one contact surface for transferring heat to the body portion by conduction, said at least one resistive element subassembly comprising a sheath, an insulator, and at least one electrically resistive element substantially electrically insulated from the sheath by the insulator, said at least one resistive element being energizable for generating heat, the body portion comprising a central part and a ridge part extending therefrom, the ridge part comprising at least one body segment;
(c) engaging the sheath of said at least one resistive element subassembly with said at least one contact surface; and
(d) engaging said at least one body segment with said at least one resistive element subassembly, to urge the sheath against said at least one contact surface.

17. A method according to claim 16 in which said at least one resistive element subassembly comprises at least one mating surface shaped for mating with said at least one contact surface, for substantially engaging said at least one mating surface with said at least one contact surface for heat transfer by conduction from said at least one resistive element subassembly to the body portion.

18. A method of forming a rib in a barbecue grill for cooking an object, the method comprising:
(a) providing a first body portion comprising a top surface adapted for engaging the object and at least one contact surface;
(b) positioning a first insulator layer on said at least one contact surface;
(c) providing a second insulator layer;
(d) positioning at least one resistive element between the first and second insulator layers, said at least one resistive element being energizable for generating heat, the first and second insulator layers and said at least one resistive element comprising an insulated heat-generating subassembly; and
(e) engaging the insulated heat-generating subassembly with a second body portion to urge the insulated heat-generating subassembly against said at least one contact surface for heat transfer by conduction from the insulated heat-generating subassembly to the first body portion, the insulator layers substantially electrically insulating said at least one resistive element relative to the first and second body portions respectively.

19. A method of forming a rib in a barbecue grill for cooking an object, the method comprising:
(a) providing a hollow body portion comprising at least one contact surface inside said body portion;
(b) positioning a sheathed element in the body portion, the sheathed element comprising a sheath in which at least one resistive element is positioned, said at least one resistive element being substantially electrically insulated by an insulator relative to the sheath, said at least one resistive element being energizable for generating heat, the insulator engaging the sheath for heat transfer by conduction from said at least one resistive element to the sheath;
(c) forming a top surface on the body portion adapted to engage the object; and
(d) forming the body portion to urge said at least one contact surface against the sheathed element, for heat transfer by conduction from the sheathed element to the body portion.

20. A barbecue grill for barbecuing an object, the barbecue grill comprising:
a plurality of elongate ribs comprising central portions respectively for supporting the object, said ribs being spaced apart from each other by at least a first preselected distance to permit liquid from the object to pass between the ribs under the influence of gravity;
at least one sheathed element comprising a sheath, at least one resistive element at least partially positioned therein, and an insulator substantially electrically insulating said at least one resistive element relative to the sheath portion, said at least one resistive element being energizable for generating heat;
said at least one sheathed element being positioned a second preselected distance below the object; and
said at least one sheathed element being connected to each said rib for transferring heat by conduction to each said rib respectively.
